(19) United States
(12) Patent Application Publication
(10) Pub. No.: US 2010/0036756 A1
(43) Pub. Date: Feb. 11, 2010

(54) Universal transaction code (UTD) used to standardize the method of capturing, storing, and retrieving transaction data

(76) Inventor: Scott Dale Van Beek, Littleton, CO (US)

Correspondence Address: Scott Dale Van Beek, 7496 S. Kendall Blvd, Littleton, CO, 80128, US

(21) Appl. No.: 12/587,577

(22) Filed: Oct. 13, 2009

Related U.S. Application Data
(62) Division of application No. 11/787,865, filed on Apr. 17, 2007.
(60) Provisional application No. 60/793,004, filed on Apr. 18, 2006.

(51) Int. Cl. G06Q 10/00; G06F 3/048; G06Q 99/00

(52) U.S. Cl. 705/28; 715/760; 705/1

(57) ABSTRACT

A new standardized Universal Transaction Code (10), as well as a standard Universal Transaction Directory (30). These two core components form the foundation of an Integrated Transaction and Accounting System (FIG. 1). This system will provide the framework to enable several disparate; identification methods, transaction accounting methods, transaction receipt methods, transaction storage methods, and website access methods to work together providing a synergistic effect. The benefits for the consumer are: simple, nearly automatic, personal finance tracking, as well as standardized transaction record and website access. An automatic way of tracking finances will increase a consumer's awareness of his or her spending practices thereby exposing and highlighting frivolous spending. The benefits for industry are: vastly increased efficiency and profit margins by reducing the dependence on outdated paper based methods, virtual elimination of “no receipt” fraudulent returns, and knowledgeable consumers focused on reducing frivolous purchases while increasing wealth building practices.

### CROSS REFERENCE TO RELATED APPLICATIONS

This is a division of the Parent application Ser. No. 11/787,865 filed Apr. 17, 2007 by the present inventor. This application claims the benefit of PPA Ser. No. 60/793,004 filed Apr. 18, 2006 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to e-commerce and personal finance. More specifically, it relates to transaction coding, a means to access to that electronic transaction data, and a means for personal database creation and management.

2. Discussion of Prior Art

Ever since the birth of the internet on 1 Jan. 1983, the world has had grand expectations of how it would affect commerce. These grand expectations envisioned miraculous leaps in technology and capabilities, whereby everyone and everything would soon become automated and interconnected. Hence, vast sums of money poured into the dot corn industry. While it was true that the advent of the internet enabled small inventions to generate enormous new and unexpected results, the reality eventually set in that long felt but unsolved needs would not miraculously disappear by throwing money at them. Expectations outpaced inventions, and the dot corn bust soon followed. The successful invention of personal finance software (PFS) some 20 years ago began the quest to organize and manage accounts and expenditures electronically and automatically. Since then, several upgrades and inventions, have improved the usability and success of e-commerce and personal finance software to the point where a consumer is now able to organize and manage accounts and expenditures electronically. Despite these advances, e-commerce has still progressed at a much slower pace than industry would like, and PFS is still not actively used in most homes. Why? You ask. The answer lies in the shortsighted, fast paced “me” society we live in. If it is not fast and easy, then it is not worth our time. Regardless of the long term benefit, the average consumer will not engage in e-commerce and PFS unless it is simple and automated. The automation required to enable widespread use of PFS, and fully realize e-commerce efficiencies, depends on standardization.

### 1 The Current E-Commerce System is Inefficient and not Widely Accepted Due in Part, to a Lack of Standardization.

Transactions generally involve exchanging money for goods or services. The method of the exchange can vary and may include other required elements, depending on the specific type of transaction. For instance, a soda pop manufacturer knows that in order to transact business, his product labeling must contain a bar code, or his market share will be non existent since nearly every grocer in the world requires it. Likewise, a banker knows that in order to transact business with other banks, a routing number is the essential code. Additionally, a merchant knows that in order to transact business with a credit card company, a merchant ID is essential. If you are dealing with the federal government, your transaction is referenced by an Employer Identification Number. If it is state, a separate number applies. Tax identification numbers may also apply. The multitude of disparate identification systems is not the only thing impeding e-commerce progress.

Currently, there is no standard method to access an electronic statement and or electronic transaction record. The consumer must first figure out what the web site address is. Does he type in supermegacorp.com, supermegacorp.net, super-megacorp.com, or super-mega-corp.net. He could use a web browser, but that would likely return all of the previous possibilities and more. He must still figure out which one is correct. Once the consumer searches for, and finds the correct web site address, each account has its own logon, and password. This typically leads to a consumer writing down logons and passwords defeating their purpose entirely. The consumer must now figure out how to navigate within the web site to the page that contains the information he is looking for. Where is the transaction reference number database page? Where is the electronic statement download page? How do I access electronic account setup information? These are all questions that have a different answer for every account that a consumer has.

There are efforts underway to standardize; however, these efforts are usually specific to each industry. For instance, the manufacturing industry uses GTIN bar codes as administered by GS1US (formerly the Uniform Code Counsel). In and effort to standardize and increase efficiency, the GTIN bar code combined the Uniform Product Code (UPC) from North America with the European Access Number (EAN) from Europe, into a single standard product bar code. The problem is that it only applies to the labeling on manufactured goods, not transactions as a whole. Likewise, the financial industry has formed Open Financial Exchange (OFX), a specification for the electronic exchange of financial data between financial institutions, business and consumers. In a press release on their Website, they state that OFX is supported by over 2000 banks, and brokerages as well as major payroll processing companies. Again, the problem here is that it only applies to financial transactions, not transactions as a whole. Obviously, the advantages of standardization have been recognized in most industries; however, the bigger, un-addressed problem is that of standardization across industry lines. Previously, any good idea has been approached as a competitive advantage within a given industry rather than an inter-industry standard that benefits all. It is this competitive advantage mentality that has prevented standardization, thereby stunting the growth of e-commerce and the acceptance of Personal Finance Software (PFS). Accordingly, there is no consensus between industries much less between competitors within an industry. How could you get Microsoft to agree with Intuit, Target to agree with Wal Mart, Visa with Master Card, and Citigroup with Bank of America? A common thread is essential, but the problem lies in implementing the new “standard” across industry and competitive lines. Standardization is the solution to rapid, widespread e-commerce and PFS acceptance.

### 2 Personal Finance Software is not Fully Automated and Therefore, Too Tedious and Confusing to be Accepted by the Average Consumer

The average consumer will not be fully engaged in e-commerce unless it is simple and automated. From the consumer perspective, Personal Finance Software has made great strides in addressing the simplicity issue. Once a consumer sets up all of his accounts, the program can be set to automatically log on to the internet and download balances, credit card statements and the like. The problem is that, despite these advances, Personal Finance Software is still too tedious and confusing for the average consumer. The first obstacle that prevents most users from using PFS is the significant amount of time required to set up all of his accounts. This process requires finding internet addresses, account numbers, login identification, login passwords, and more for each account to be created, followed in some cases by the creation of categories for transactions. Some PFS contains an automatic categorization feature, but there is no standard, and most are prone to erroneous postings. Although the download feature of PFS has simplified the process, there is no standard for account setup and categorization. Therefore consumers who do use PFS typically find themselves manually entering data. PFS also typically contains an account balance feature. This feature is also tedious and requires manual entry, inviting error and considerable time “balancing” the account. There is currently no method to electronically capture point of sale records and then automatically “balance” them with the electronic statement. PFS will become much more attractive to the masses when it becomes an automatic process. Only then will the average Joe come to understand the “latte” factor. This is when he comes to realize how much money is actually being spent on that everyday vice instead of investments, education and other wealth building endeavors.

### 3 The Current Transaction System is Too Dependant on Costly Traditional, and Paper Based Methods.

Paper based and other traditional transaction methods are far more costly than electronic transaction methods (Internet). Therefore, the problem to solve lies in persuading customers to transact business online rather than depending on paper based, or other traditional methods. For example, per transaction banking costs look something like this: $1.06 branch, 0.74 mail, 0.52 phone, 0.25 ATM, 0.01 Internet. The traditional paper based bank statement, or credit card statement is similarly inefficient. The potential cost advantage of an electronic vs. a paper based system could have a huge affect on efficiency and profit margin. Another element of the paper based system that is costly for industry is the paper receipt. Many retailers have liberal return policies due to the fact that many customers fail to save their paper receipt. Retailers could require the paper receipt for a return, but risk losing customers due to the inconvenience. As a result, retailers often absorb some level of fraudulent returns. In an effort to curtail this loss, retailers often only offer a store credit for returns without a receipt. This policy can inconvenience a customer who lost his receipt, but is making a legitimate return. Although consumers lose paper receipts regularly, it is standard practice for merchants to archive transaction records (electronic receipts) for extended periods. The problem of fraudulent returns could be dramatically reduced if consumers could rely on the archived electronic transaction record rather than the paper receipt record obtained at the point of sale.

Automated PFS could make things fast, while standardization could make things simple. Once those two problems have been addressed, traditional and paper based methods will begin to fade away and large scale efficiencies will be realized. There are several prior art systems and patents in existence for bill presentment. There are also prior art smart card systems and patents that combine accounts on one card, download receipts to a card, put account images on a card, and allow a consumer to define transaction categories on a card. All of these systems are an attempt to simplify e-commerce. As a result, there is obviously an established need to simplify e-commerce for the consumer. It benefits the consumer with an increased awareness of his financial status, and it benefits industry in the form of lower cost through increased efficiency. Following is a list of Prior Art that relates to the current invention. The current invention will either address shortcomings of inventions in the list, or it will provide the mechanism to make inventions in the list more successful.

### Identification Systems

Internet Address Protocol
Federal Employer Identification Number
State Employer Identification Number
Tax ID Number
Financial Institution Routing Number
Merchant Identification Number
GTIN Manufacturer's ID

### Personal Finance Software—Category Classification

U.S. Pat. No. 6,792,422 to Stride (2000) is a character recognition program by Microsoft that automatically categorizes a financial transaction based upon alphanumeric characters present in a textual description of the transaction. While this invention does accomplish the goal of categorizing expenditures for personal finance software (PFS) it requires database and processing time. Additionally, the possibility of ambiguity and mischaracterization will always exist. Last, it is used as a competitive advantage, and is therefore proprietary and non-standard.

U.S. Pat. No. 5,842,185 to Chancey (1994) is a process by Intuit that determines from the electronic statement a merchant category code such as a Standard Industry Code (SIC). Two difficulties arise with this invention. First, most statements do not include the (SIC). Second the (SIC) now updated as the North American Industry Classification System (NAICS) in order to standardize U.S., Canadian and Mexican classifications, is a 1400 page document that is much too detailed and complicated to be included and referenced in every transaction.

Point of Sale—Transaction Recording and/or Category Classification

U.S. Pat. No. 5,559,313 to Claus (1994) is a process by Lucent where a smart card responds to a transaction list from a point of sale (POS) terminal to automatically insert these items into expense categories. This invention is an elaborate construct of look up tables within a smart card, which contains the alphanumeric descriptions utilized for a particular industry. Just as in the Microsoft invention, anytime there is a dependence on alphanumeric descriptions, the possibility of ambiguity and mischaracterization exists. Additionally, the potential to extend, rather than shorten the time required to complete a transaction exists.

U.S. Pat. No. 5,748,908 to Yu (1995) is a system for encoding POS terminals with a category code by using color coded cards. The current invention would aid in the acceptance of this patent. This patent is only capable of categorizing the total purchase at the point of sale terminal level, while the invention is capable of categorizing at the individual item level.

U.S. Pat. No. 6,353,811 to Weissman (2000) is a system for allocating transaction expenditures incurred by a credit cardholder, and accrued interest attributable thereto, to sub-accounts specified at the point of purchase by the person incurring the charge. The problem with this invention is that by allowing the consumer a decision making process at the point of sale, the time required to complete a transaction would increase. The market tends to dictate that current advances shorten rather than lengthen transaction completion times.

U.S. Pat. No. 6,738,749 to Chasko (2004) is a system by NCR Corp. for creating, storing and retrieving secure transaction receipts on portable electronic media that can be carried by a consumer. The invention would contribute to acceptance of this patent. This patent requires that the consumer remember to bring the electronic media, and remember to capture the transaction data. The invention can rely on a merchant's database which is longer lasting, will always be recorded, and is less likely to be lost.

The above patents and prior art are all attempts at solving the problems inherent in e-commerce and PFS. Although they are good ideas, they only address a small piece of the overall puzzle. The invention defines the forest and makes the entire forest better, while the above patents only look at improving individual trees.

### OBJECTS AND ADVANTAGES

Accordingly, several objects and advantages of my invention are:

### 1 To establish an Integrated Transaction and Accounting System (ITAS)

The overall invention is a systematic method that more smoothly integrates transactions with the process of accounting for them. The invention is generally an addition to, rather than a replacement for, existing systems. As a result, the invention will create a synergistic effect by bringing together new ideas and prior art to generate a whole that is greater than the sum of its parts. This flexibility to integrate existing transaction and accounting methods and systems should open the door to many new and possibly unexpected efficiencies, and time savings.

### 2 To establish a Universal Transaction Directory (UTD)

The advantage of a standardized directory is that the directory deals with the many different identification systems, transaction codes, product codes, access protocols, web page formats, reference number databases etc. . . . The consumer benefit, is that the process looks the same whether he is setting up a PFS account, downloading transactions, looking up a receipt, balancing an account, or just online shopping. The institution registered in the directory benefits from lower transaction costs, since statements and transactions are much more likely to be accessed electronically due to the standardized format. The benefit to merchants registered in the directory lies not only in the form of increased web site and e-shopping traffic, but also in the form of reduced fraud. Electronic transaction receipt records can be retrieved from a merchant's reference number database by the consumer. This would dramatically reduce the number of fraudulent merchandise returns by eliminating the dependence on the point of sale transaction receipt. There is prior art that seeks to record transactions records from point of sale terminals to personal storage media. The current invention would serve to enable this prior art. Additionally, the invention has an advantage over this prior art in that the transaction record could be accessed from the registrant's transaction reference number database via the standardized directory. This database is likely to have a much larger capacity, and therefore be maintained for a much longer period of time than a consumer's portable storage media. Another advantage of the invention is that a consumer does not have to remember to bring the storage media to each transaction, or remember to record the transaction.

All in all, the standard directory is a previously un-suggested combination of disparate systems unified to solve a long felt need. It succeeds where others have failed, in that it enables standardization without stifling the creativity of several different systems by requiring that they change.

### 3 To establish a Universal Transaction Code (UTC)

While the Universal Transaction Directory (UTD) is the conduit through which these many disparate systems talk, the Universal Transaction Code (UTC) is the common language that enables these disparate systems to speak to each other.

(b) One key object of the UTC is a Universal Identification Code (UID). This identification code would have the advantage of flexibility in that its structure is flexible enough to accommodate a variety of existing ID codes. An institution could choose to register one of its current ID's, such as a tax ID, merchant ID, routing number, employer ID, etc. . . . OR it could choose an independent number for its UID. Another advantage of the Universal Identification Code would be the ability to hyperlink to the main web page of the UID owner, by clicking on the UID in an electronic statement. In this way, consumers would have easier access than ever before; thereby increasing institution exposure via the internet well beyond current levels.

(c) A second key object of the UTC is a Universal Category code (UCC). The Universal Category Code is a number that corresponds to a transaction category from a standard list of debit/credit categories. The advantage of a standard category list is that if merchants and institutions code their transactions and products with a standard category, the average consumer's Personal Finance Software (PFS) could not only automatically download a transaction, but categorize it as well. For advanced users, the category could be modified, or even overridden within the personal finance software.

(d) A third key object of the UTC is a User Defined Code (UDC). The User Defined Code is a field within the UTC that allows the user the flexibility to put code into the transaction in order to suit individual needs. For example, a merchant could put the transaction number in the UDC field. An advantage here would be the ability to click on the UDC field in an electronic statement and hyperlink to the merchants' reference number database web page to see the electronic receipt, detailing items purchased in the transaction. This “receipt” file could be saved to disk, or printed for a merchandise return.

### 4 To Create ITAS Enabled Storage Media Used to Automate the PFS Experience

If the Universal Transaction Directory (UTD) is the common conduit through which these systems talk, and the Universal Transaction Code (UTC) is the language they speak, then storage media is the mechanism defining the topic that is discussed. The advantage of storage media is that it will almost fully automate the process.

(a) An object of ITAS encoded storage media is to establish a standardized Automatic Account Setup protocol whereby consumers' accounts are automatically set up in a Personal Finance Software (PFS) program by simply inserting ITAS storage media in the computer. The data on the storage media would not only include account setup but also automatic internet log on instructions for the (PFS) to use for account updating purposes. The obvious advantage here is that the consumer would not only save time, but would also be more inclined to use e-commerce features since they are automated.

(b) Another object of the invention is an automatic account download and categorization system. This aspect of the invention improves a feature already available in current prior art personal finance software. In addition to downloading transactions in an electronic statement, the invention would also automatically categorize transactions, allow for modifications, and then post the transactions to specific accounts. For the basic user, this process would be almost completely automatic. The invention is also structured to allow for intermediate and advanced users to set up very specific features which then run automatically. Additionally, the invention could automatically categorize not only at the transaction level as current PFS does, but also at the item level via transaction reference number databases. Again, the obvious advantage here is that the consumer would not only save time, but would also be more inclined to use e-commerce features since they are automated.

(c) Another object of the invention is an automatic account balancing system. This aspect of the invention involves purchase transactions. At the point of sale, the Universal Transaction Code (UTC) would not only be transmitted to the bank or credit card company, it would also be transmitted to the consumers' portable storage media. This would likely be the debit card or credit card used, which using current technology would likely be a smart card with storage capacity. Later, when the consumer slides the card into his home computer's card reader, not only would the computer recognize the account as having been established and prompt for statement download from the internet, but it would also upload and compare the actual transactions captured on the smart card at the point of sale to perform an automatic account balancing function with the downloaded electronic statement. Although there is a balancing function in prior art, the transactions must be manually entered. The current invention simplifies and increases the accuracy of the process.

Further objects and advantages of my invention will become apparent from a consideration of the drawings and ensuing description.

### SUMMARY

An Integrated Transaction and Accounting System (ITAS), is one that will serve as a unifying and enabling system. Several mutually exclusive methods, identifications, and systems will be able to use the (ITAS) to standardize transaction format. Standardizing transaction format will increase acceptance of the current e-commerce system, and enable personal finance software programs to make the previously tedious process of tracking finances almost completely automatic. The result will be a significant advance in the efficiency of the commerce system and personal finance software of today.

### DRAWINGS

### Figures

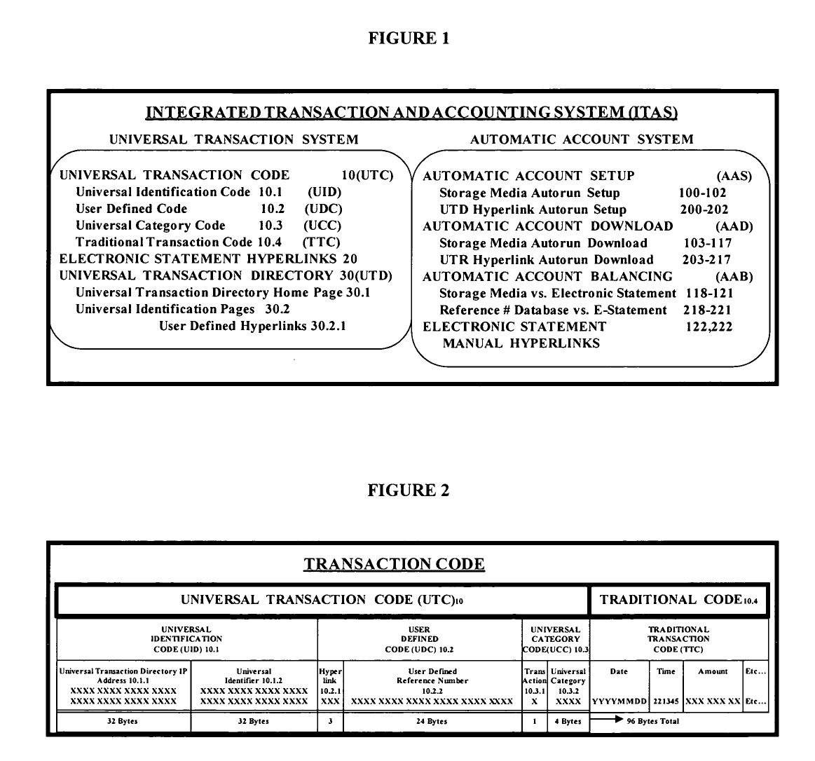

FIG. 1 shows the overall components of the Integrated Transaction and Accounting System.

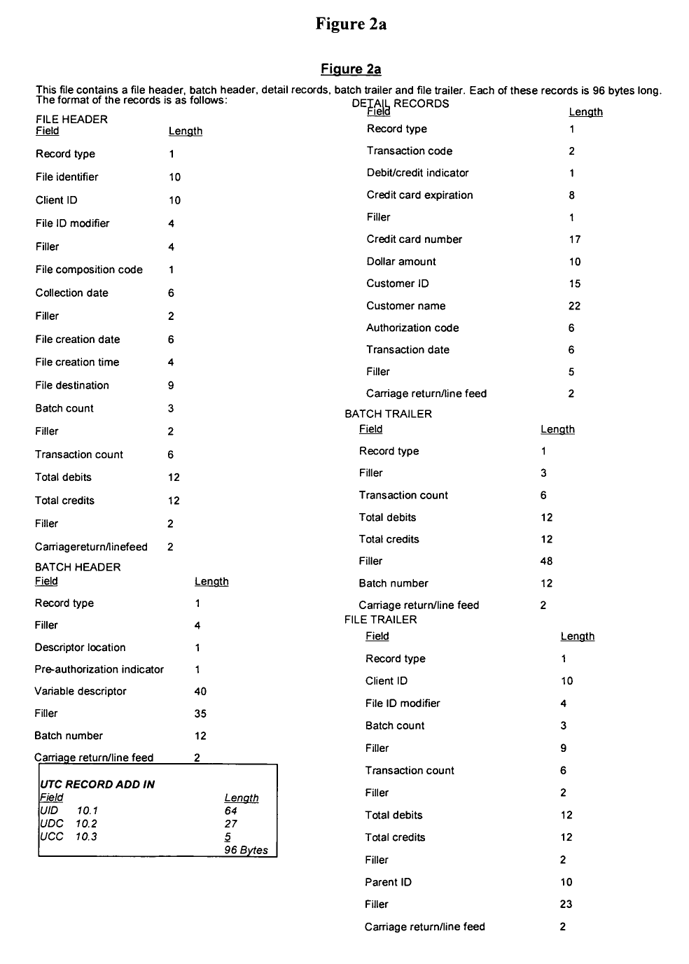

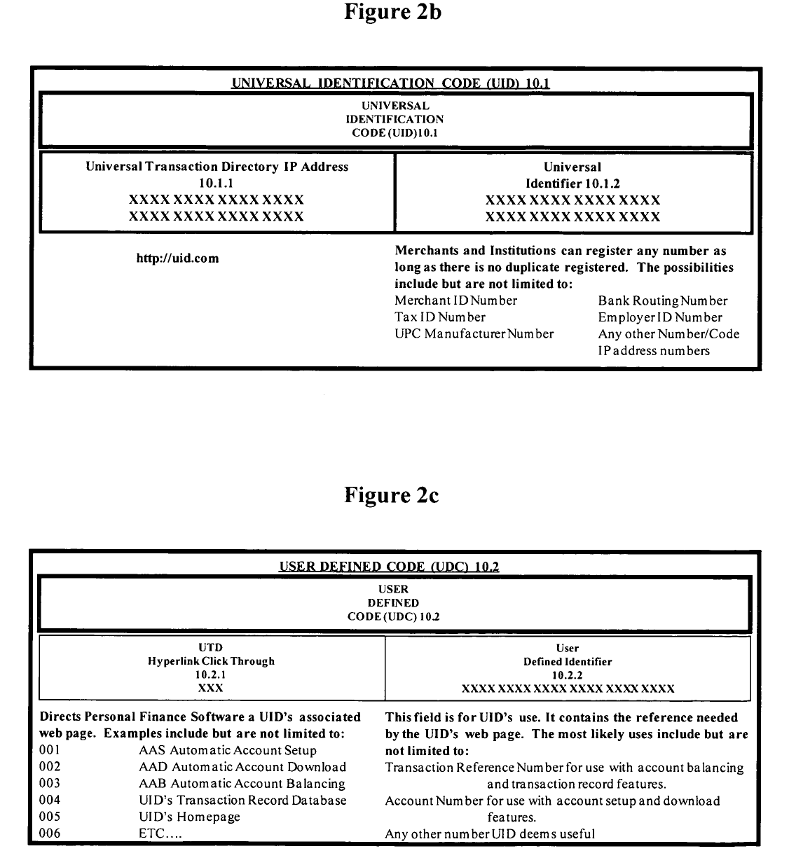

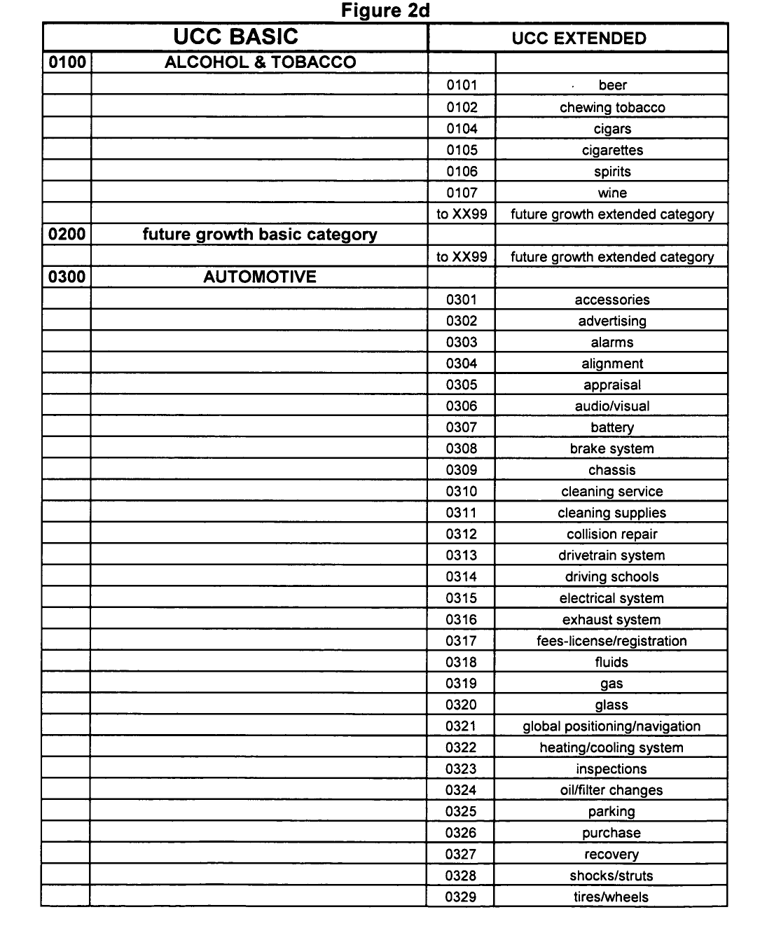

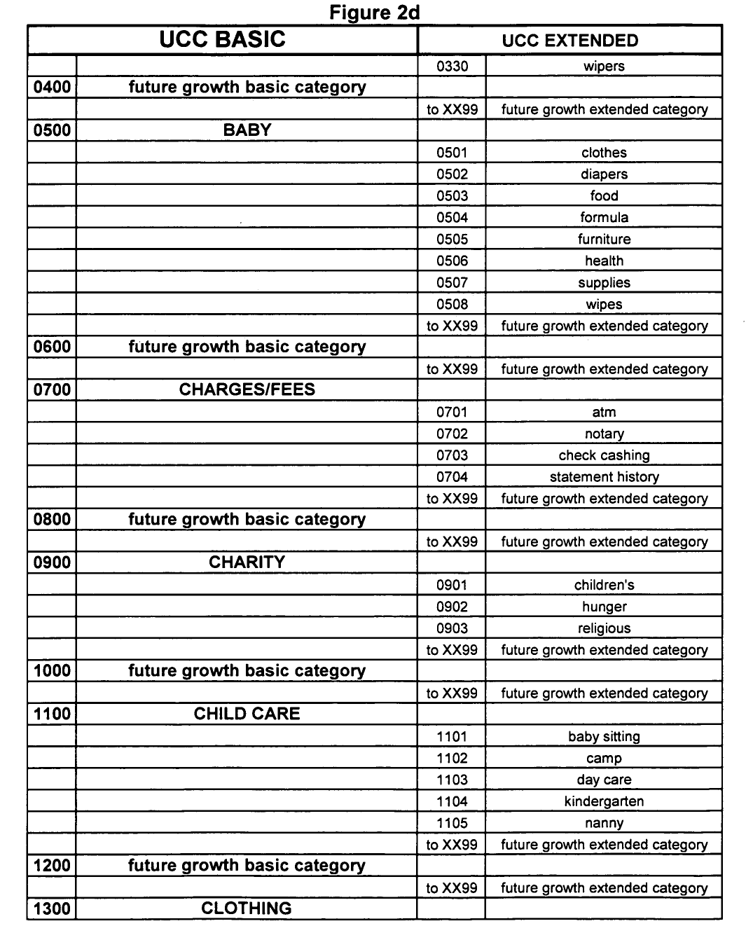

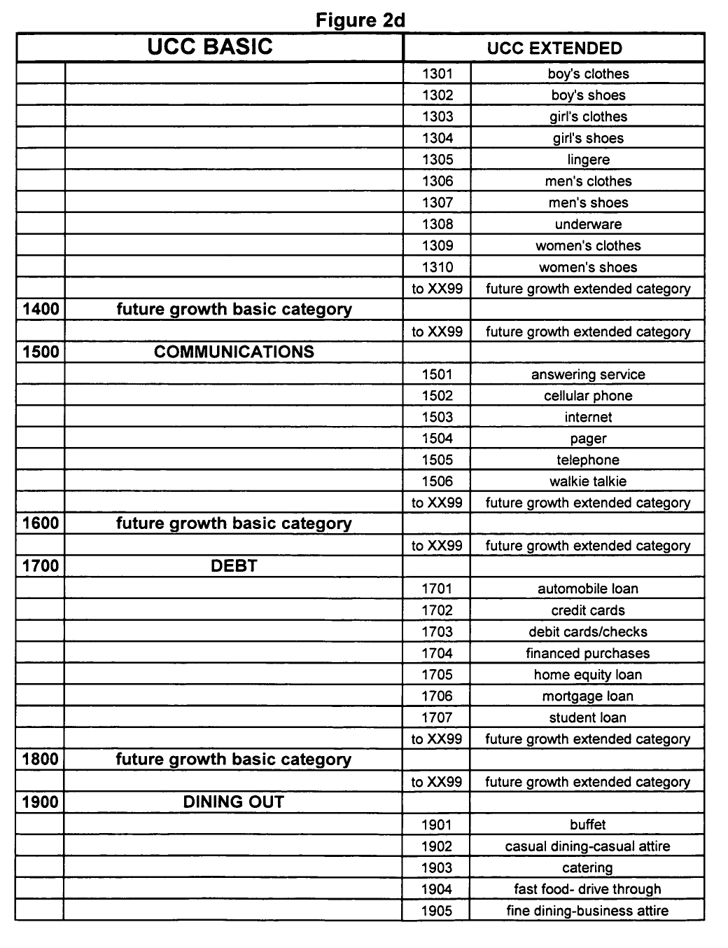

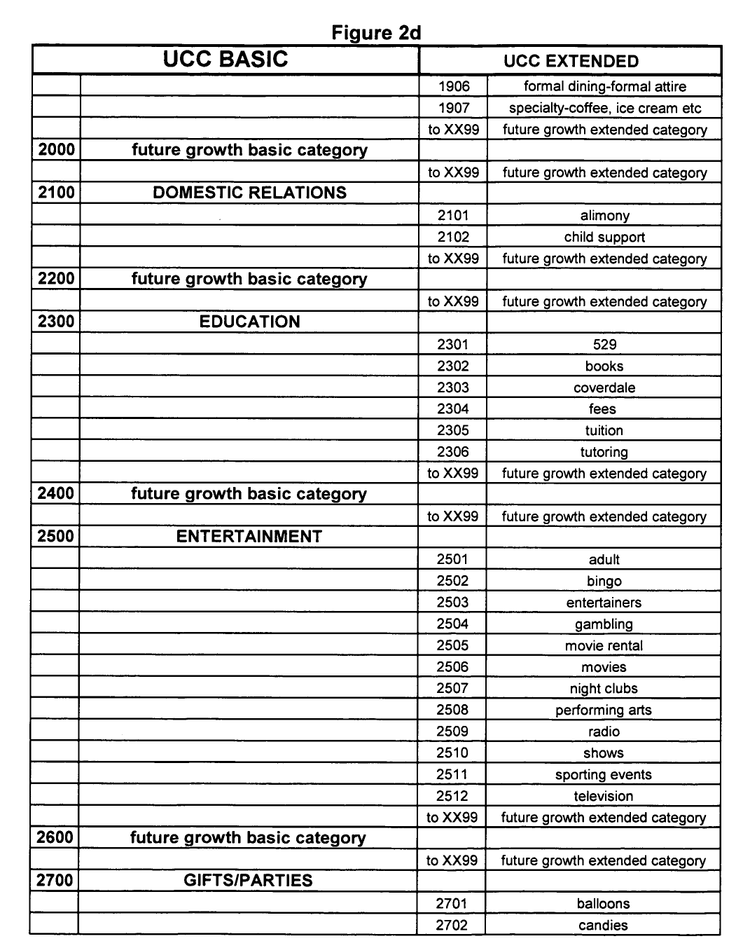

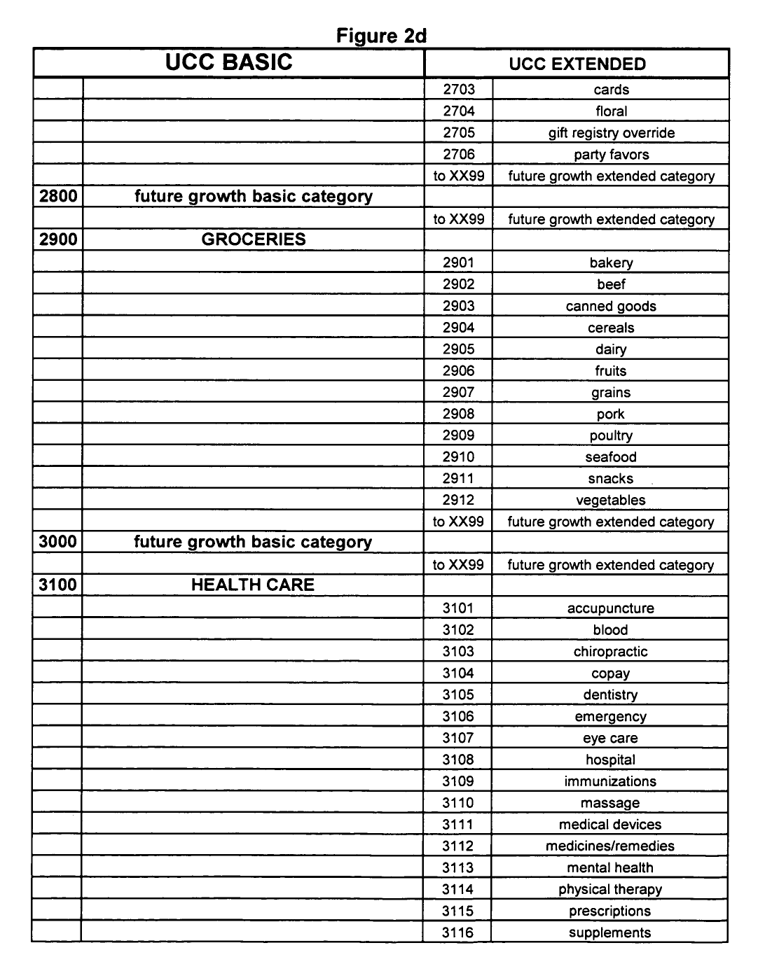

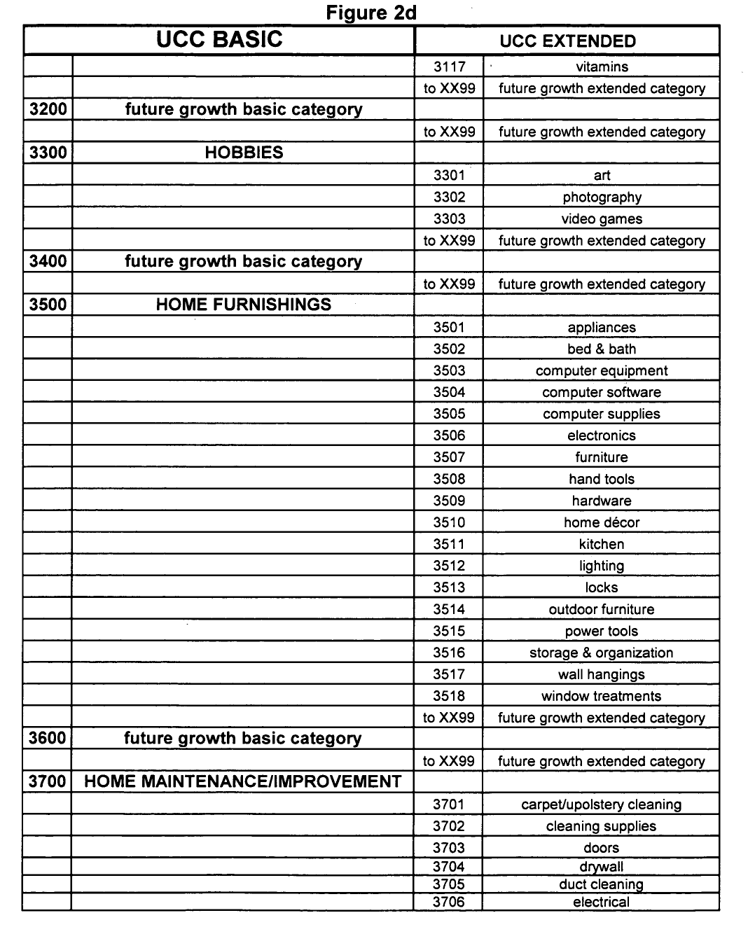

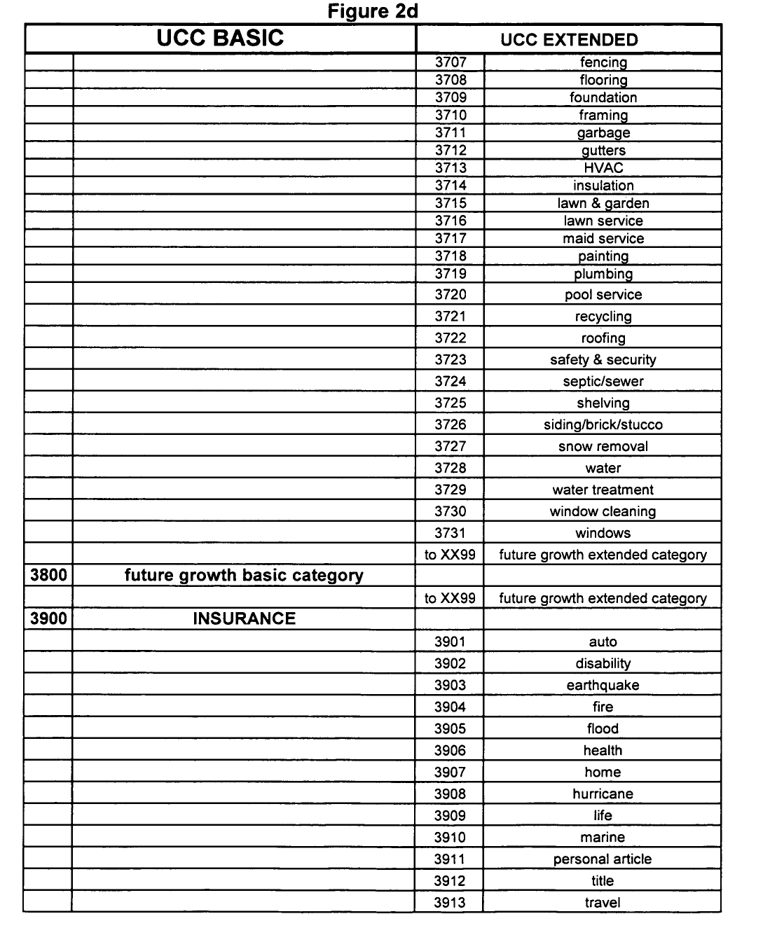

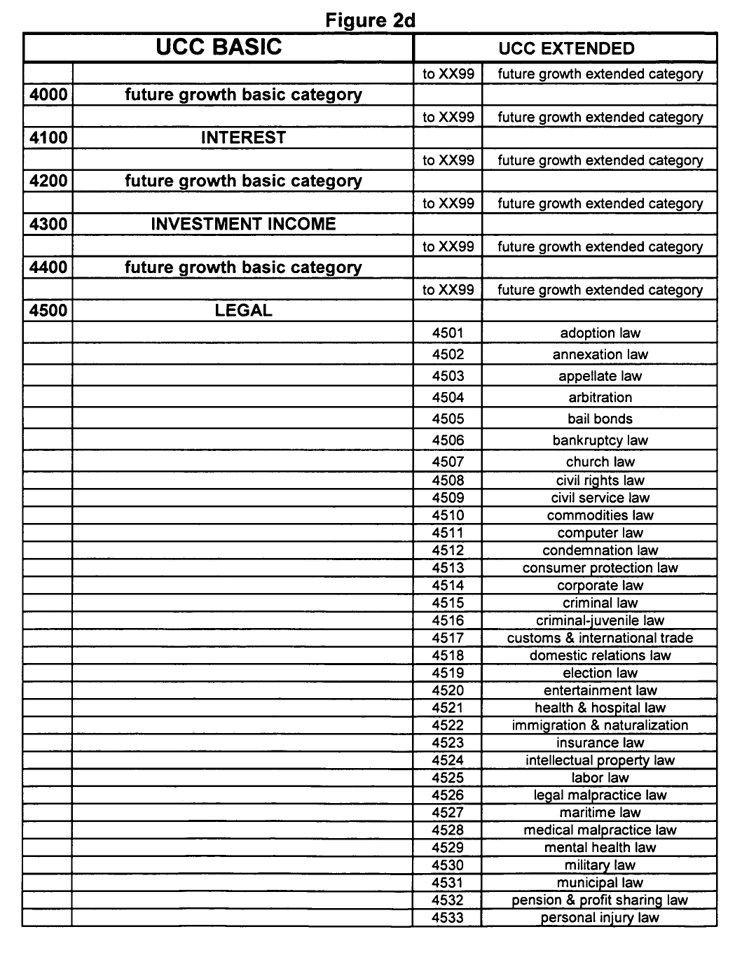

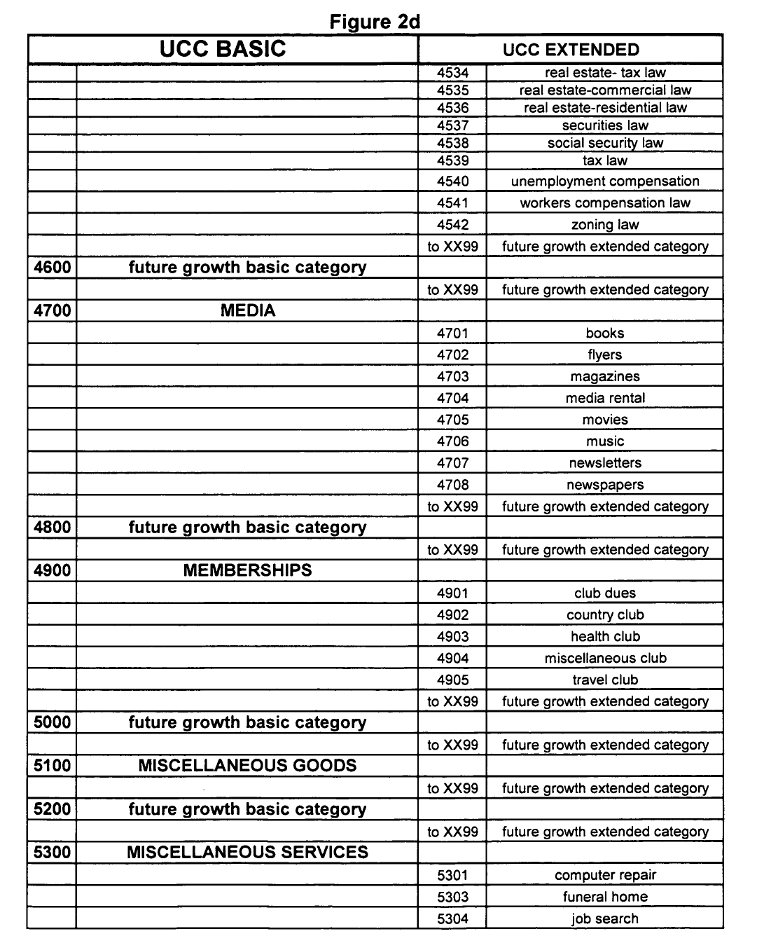

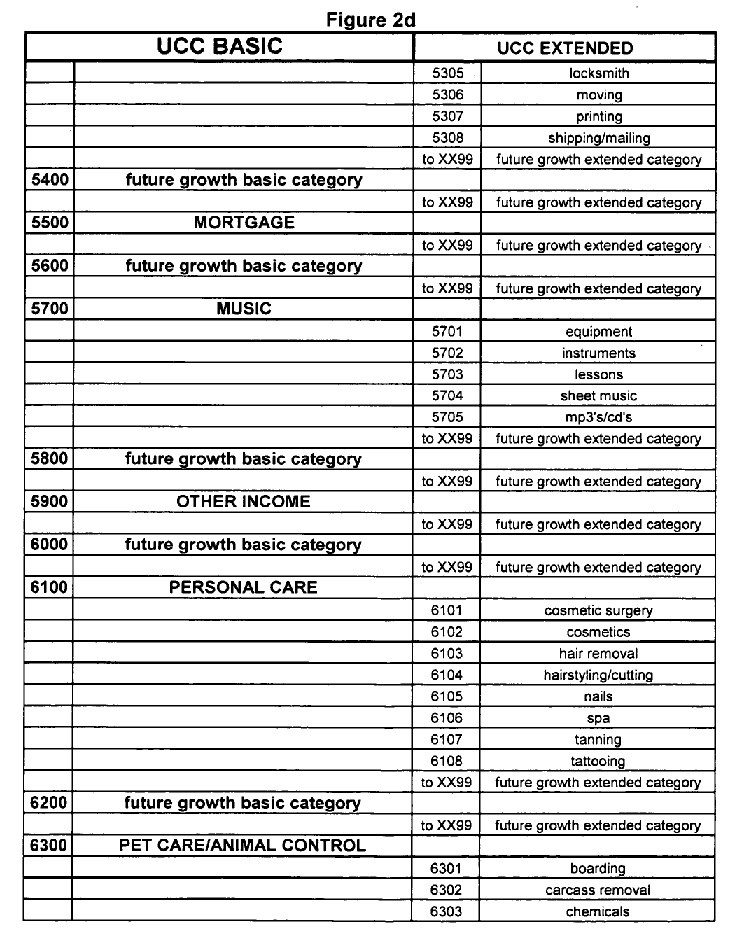

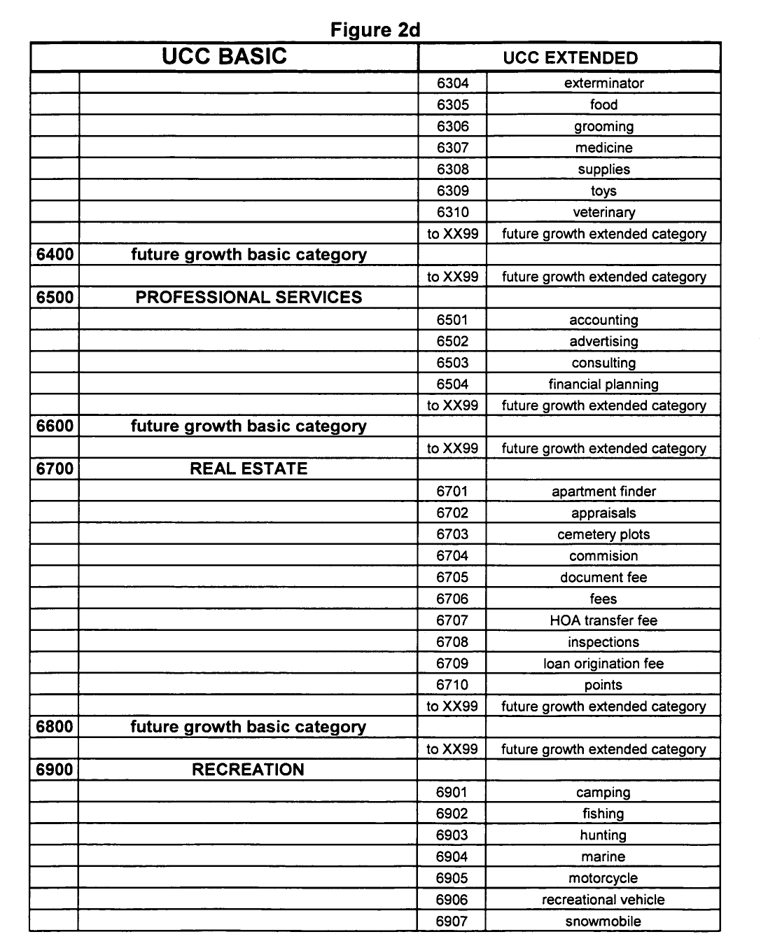

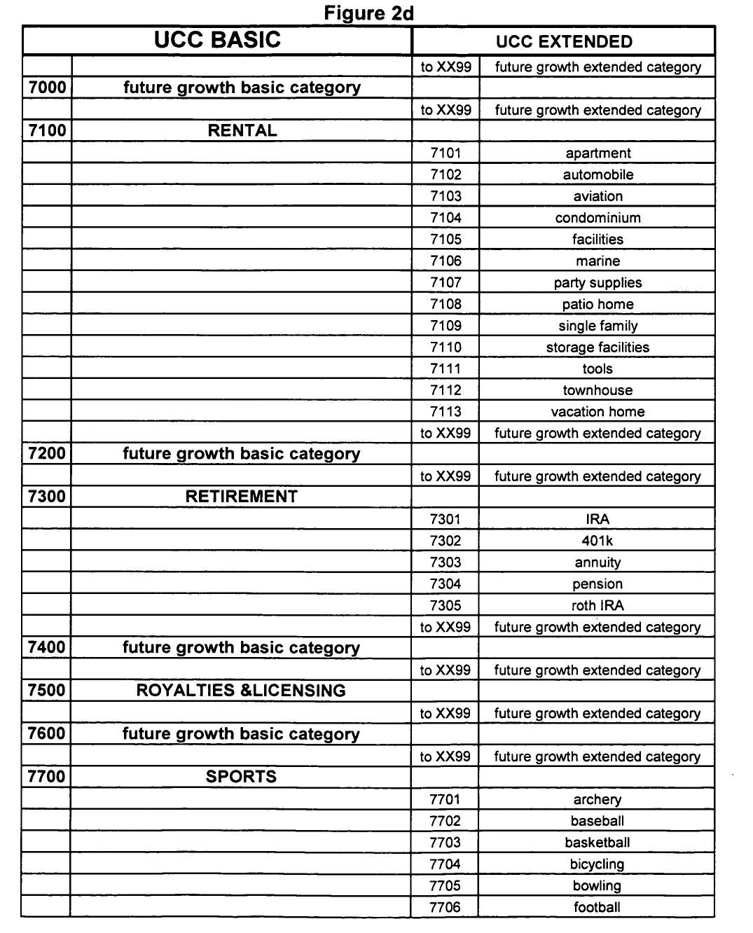

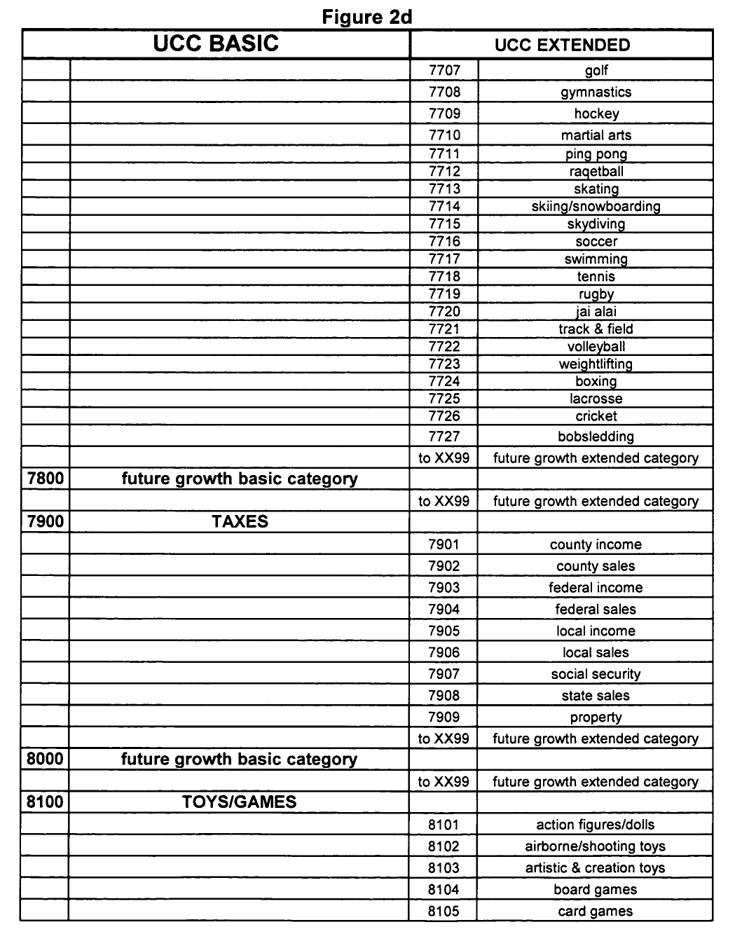

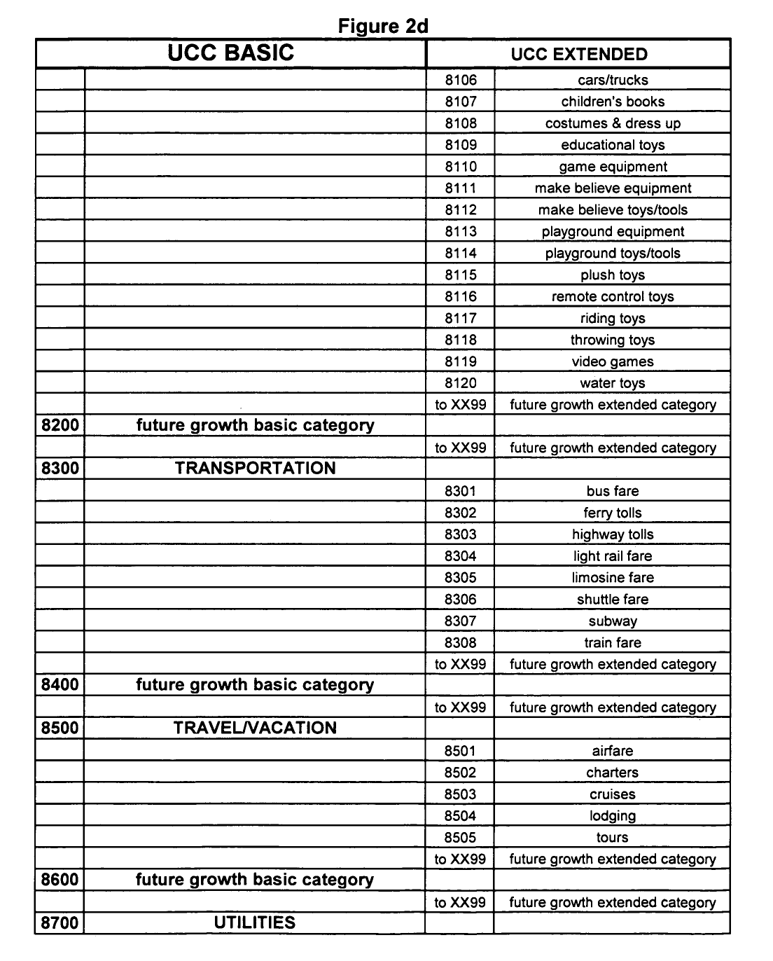

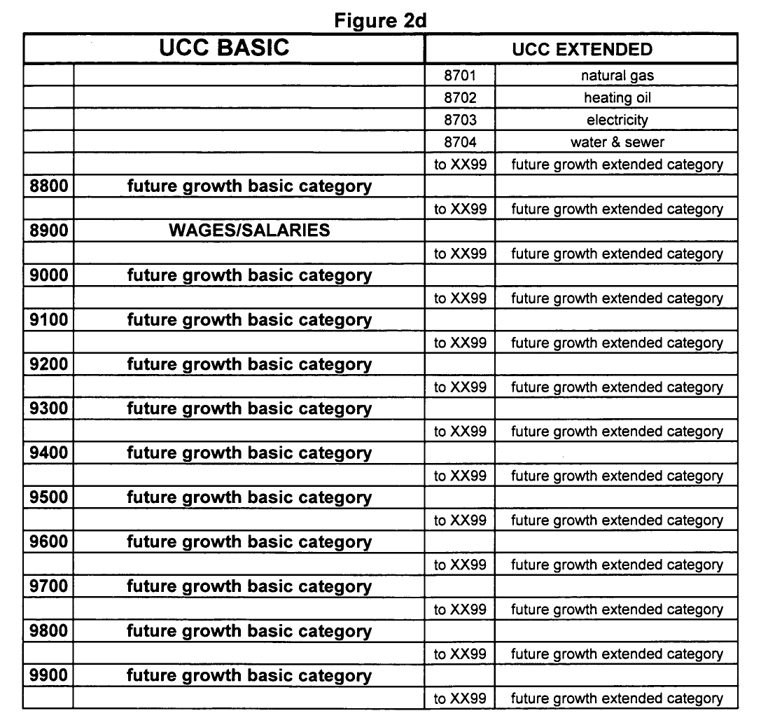

FIG. 2 shows the basic structure of the Universal Transaction Code (UTC). FIG. 2a shows an existing transaction code sample, and the ability to add the Universal Transaction Code (UTC) embedded as a unified code, or separated into filler positions within the transaction code.

FIG. 2b shows an expanded view of the Universal Identification Code (UID) in FIG. 2.

FIG. 2c shows an expanded view of the User Defined Code (UDC) In FIG. 2.

FIG. 2d shows an expanded view of the Universal Category Code (UCC) format in FIG. 2.

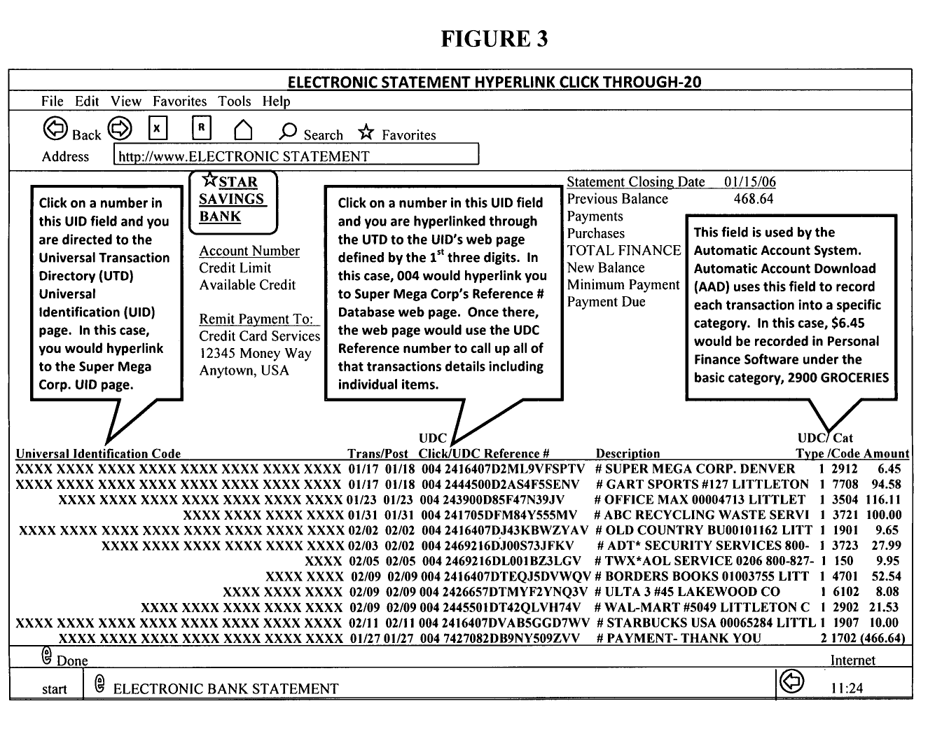

FIG. 3 is a depiction of an existing credit card statement and how the Universal Transaction Code (UTC) would be used in an electronic statement.

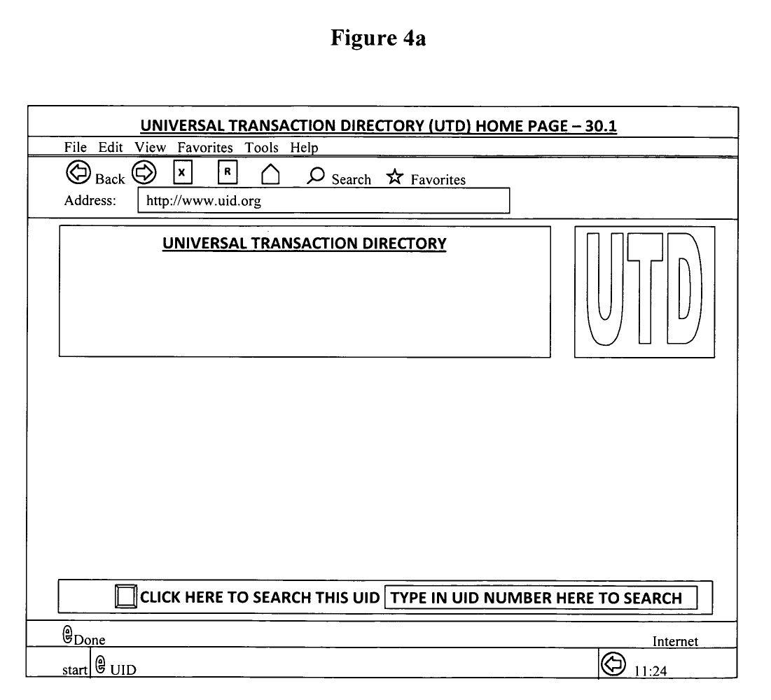

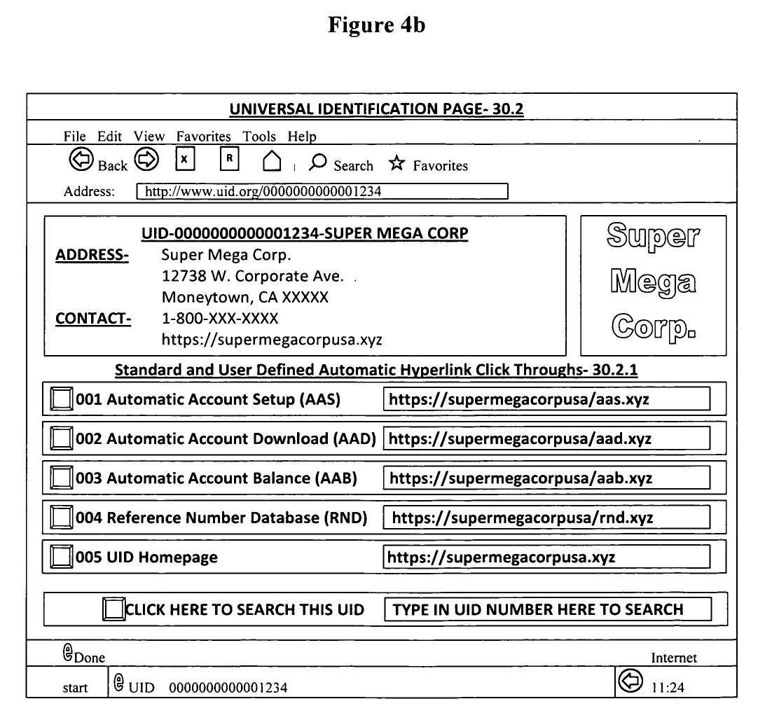

FIG. 4a is an example of the Universal Transaction Directory (UTD) homepage.

FIG. 4b is an example Universal Identification (UID) page for the fictitious Super Mega Corp.

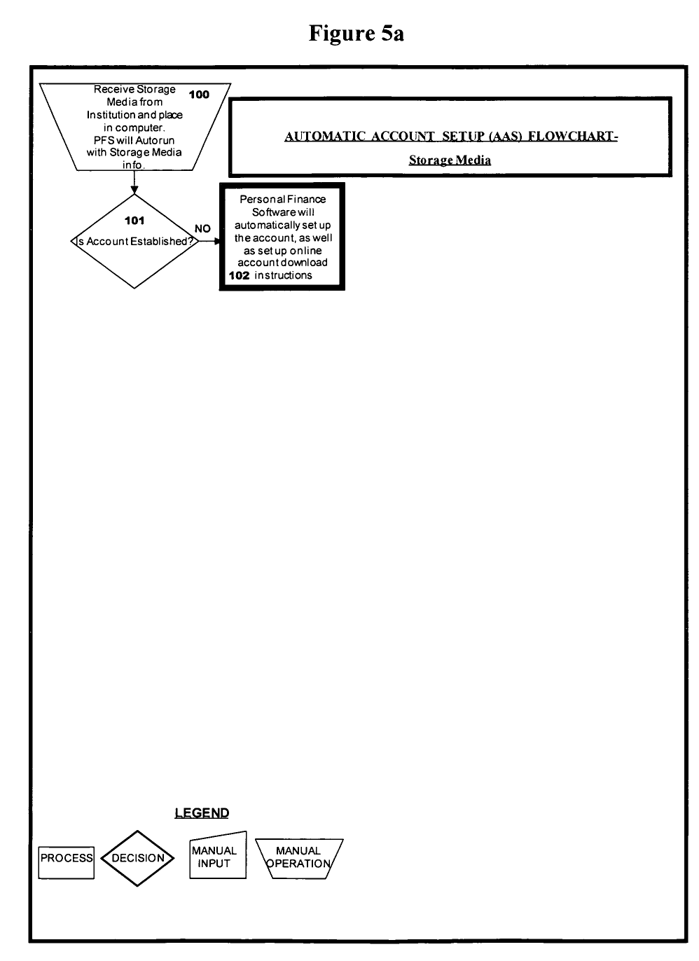

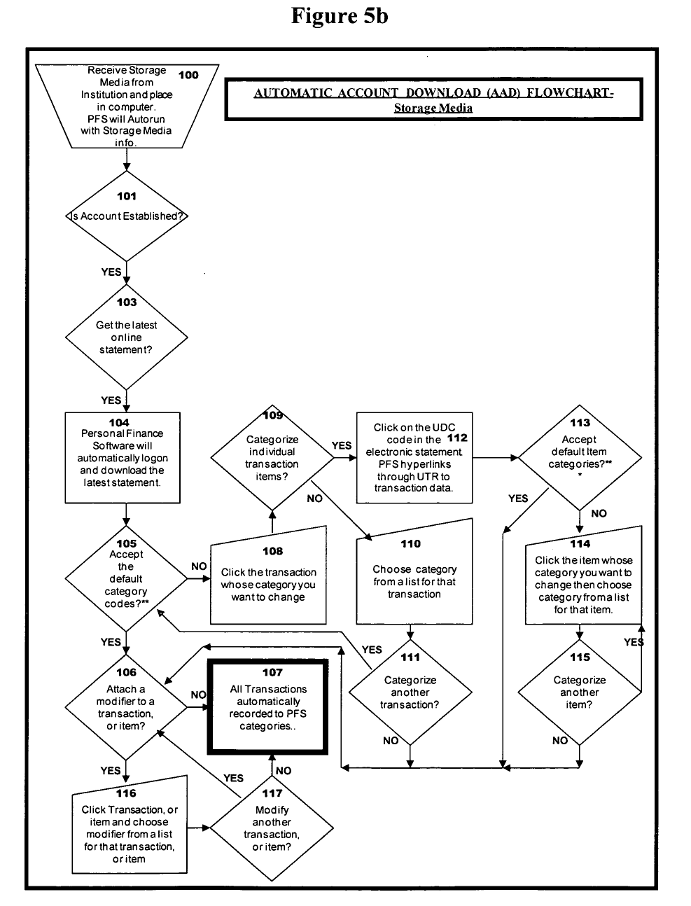

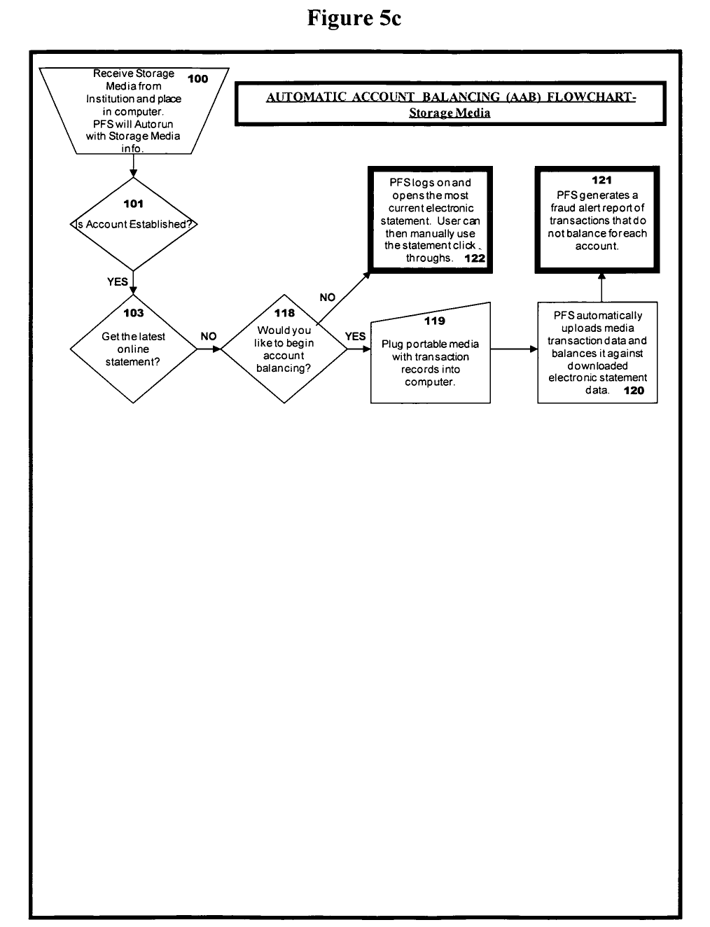

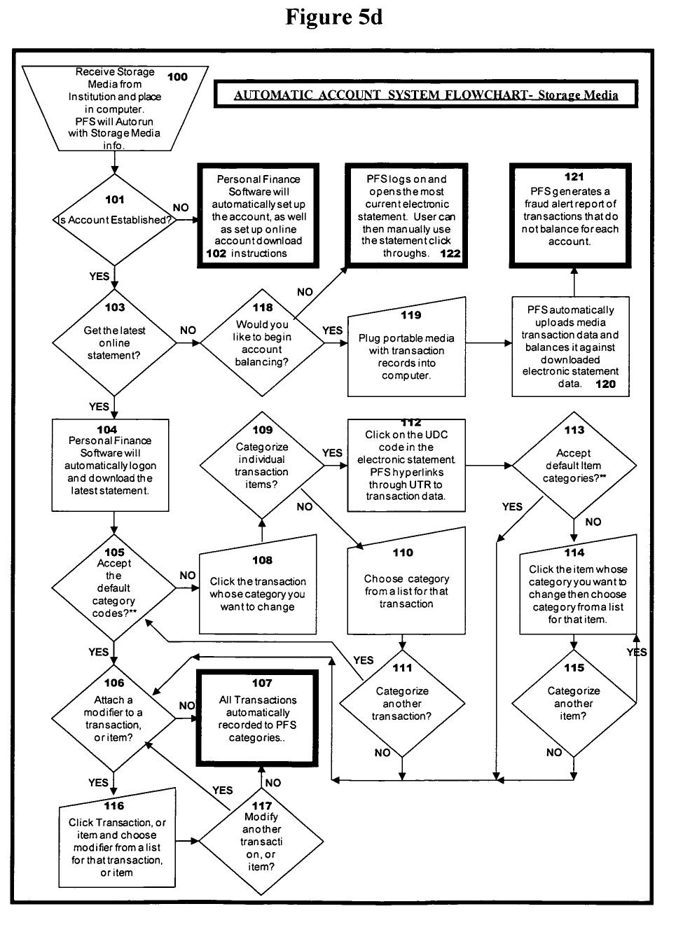

FIG. 5a is a flowchart relating to Automatic Account Setup (AAS) using the preferred embodiment of Storage Media.

FIG. 5b is a flowchart relating to Automatic Account Download (AAD) using the preferred embodiment of Storage Media.

FIG. 5c is a flowchart relating to Automatic Account Balancing (AAB) using the preferred embodiment of Storage Media.

FIG. 5d shows the entire flowchart for the Automatic Account System using the preferred embodiment of Storage Media.

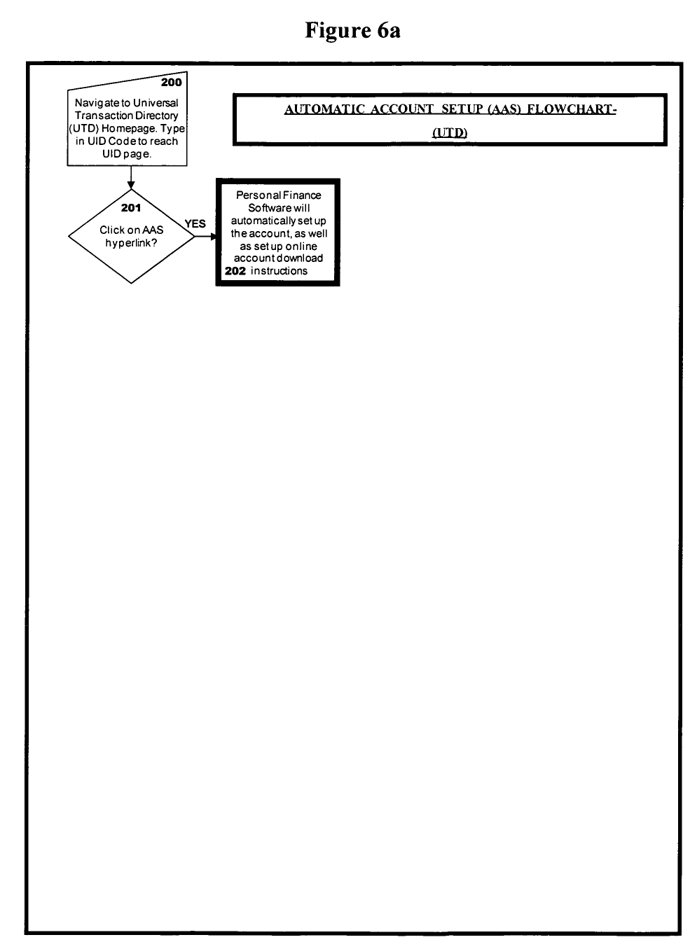

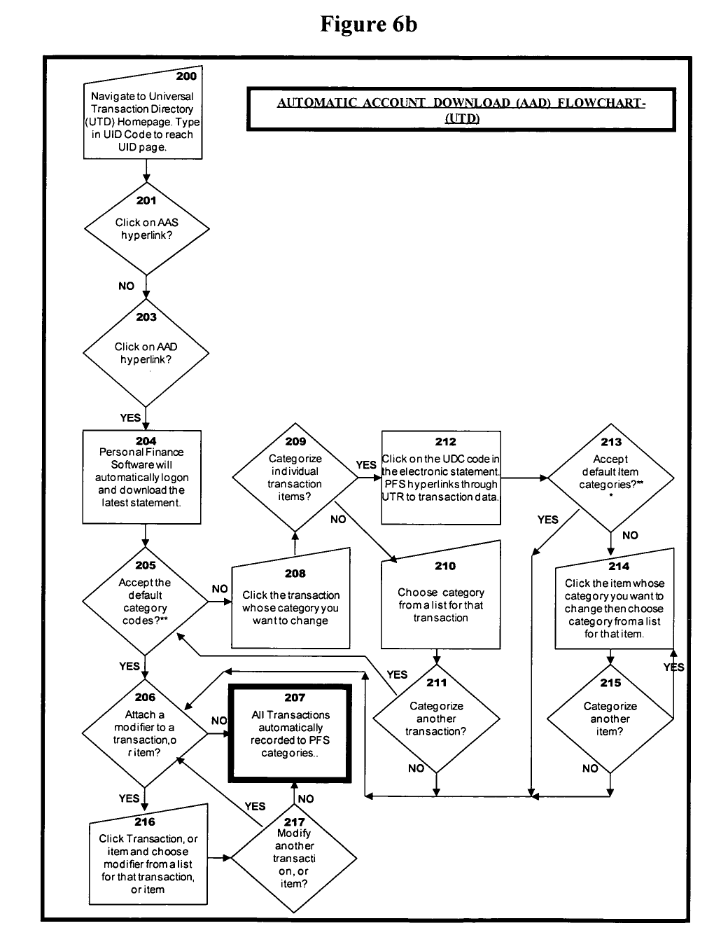

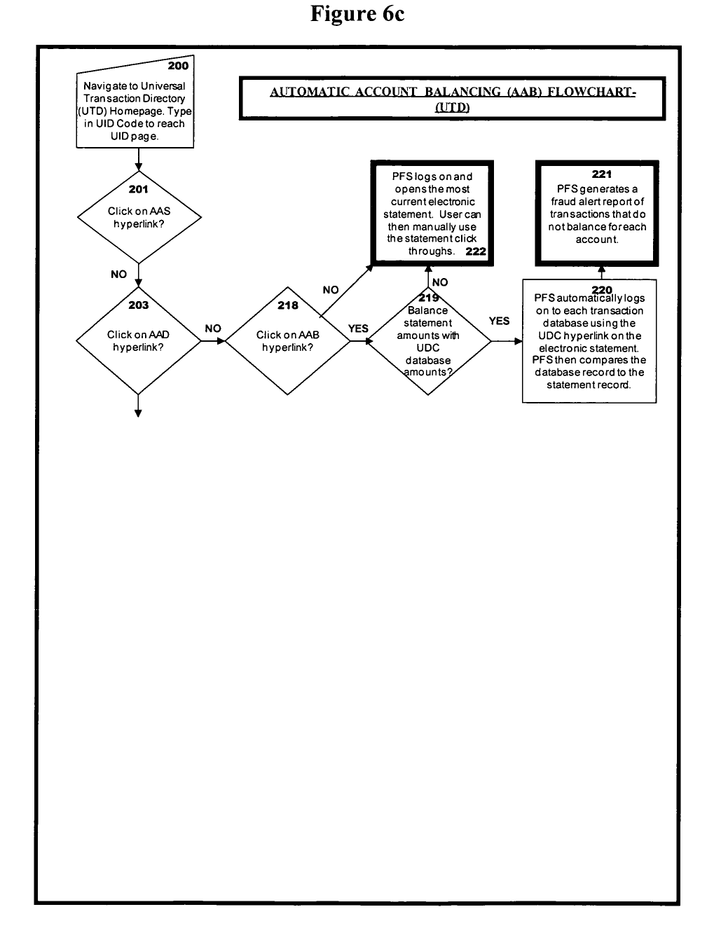

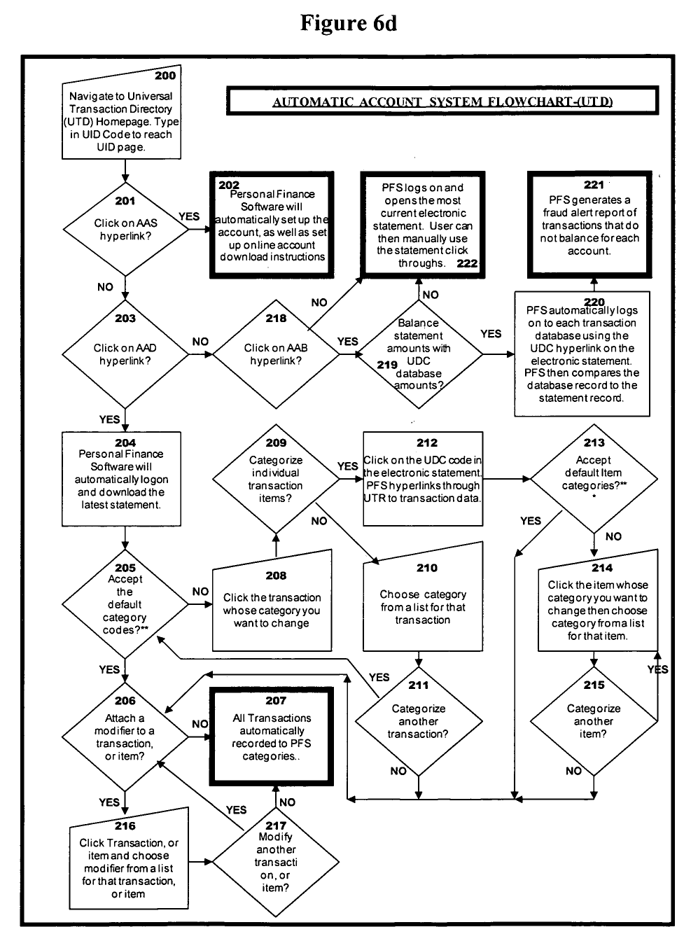

FIG. 6a is a flowchart relating to Automatic Account Setup (AAS) using the alternate embodiment, the Universal Transaction Directory (UTD).

FIG. 6b is a flowchart relating to Automatic Account Download (AAD) using the alternate embodiment, the Universal Transaction Directory (UTD).

FIG. 6c is a flowchart relating to Automatic Account Balancing (AAB) using the alternate embodiment, the Universal Transaction Directory (UTD).

FIG. 6d shows the entire flowchart for the Automatic Account System using the alternate embodiment, the Universal Transaction Directory (UTD).

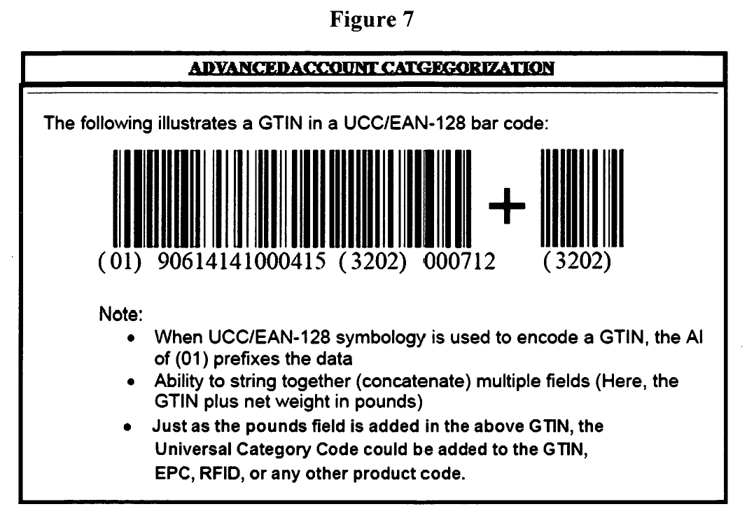

FIG. 7 is a depiction of the Universal Category Code (UCC) embedded within an existing Global Transaction Identification Number (GTIN).

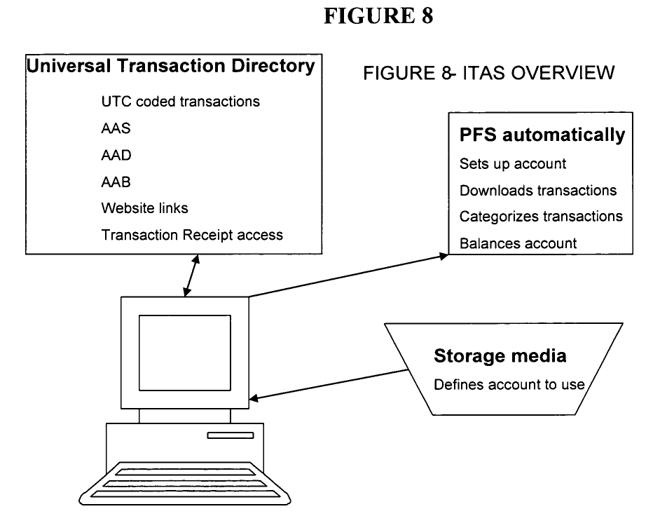

FIG. 8 is a graphic summary of the ITAS system.

### NUMERALS

### Universal Transaction System Reference Numerals

10 UNIVERSAL TRANSACTION CODE (UTC)
10.1 Universal Identification Code (UID)
10.1.1 Universal Transaction Directory IP Address
10.1.2 Universal Identification Number
10.2 User Defined Code (UDC)
10.2.1 Universal Transaction Directory Click Through Hyperlink
10.2.2 User Defined Reference Number
10.3 Universal Category Code (UCC)
10.3.1 Transaction Type
10.3.2 Universal Category
10.4 Traditional Transaction Code (TTC)
20 ELECTRONIC STATEMENT HYPERLINKS
30 UNIVERSAL TRANSACTION DIRECTORY (UTD)
30.1 Universal Transaction Directory Homepage
30.2 Universal Identification Page
30.3 User Defined Hyperlink

### Automatic Account System Sequence Numerals

| | |
|---|---|
| 100-102 | AUTOMATIC ACCOUNT SETUP (AAS) via Storage Media |
| 103-117 | AUTOMATIC ACCOUND DOWNLOAD (AAD) via Storage |
| | Media |
| 118-121 | AUTOMATIC ACCOUNT BALANCING (AAB) via Storage |
| | Media |
| 122 | ELECTRONIC STATEMENT MANUAL HYPERLINKS |
| | Storage Media |
| 200-202 | AUTOMATIC ACCOUNT SETUP (AAS) via Directory (UTD) |
| 203-217 | AUTOMATIC ACCOUNT DOWNLOAD(AAD)via Directory |
| | (UTD) |
| 218-221 | AUTOMATIC ACCOUNT BALANCING (AAB) via Directory |
| | (UTD) |
| 222 | ELECTRONIC STATEMENT MANUAL HYPERLINKS |
| | via Directory (UTD) |

### DETAILED DESCRIPTION

### FIG. 1 Integrated Transaction and Accounting System (ITAS).

FIG. 1 shows the overall components of an Integrated Transaction and Accounting System (ITAS). There are two main sections to the ITAS.

The first section of the ITAS is a Universal Transaction System. It consists of a standardized Universal Transaction Code (UTC), which is included in all transactions regardless of type. Since the standardized code elements are included in a transaction, they are also included on any electronic statement. The UTC code within an electronic statement is a hyperlink through a standardized Universal Transaction Directory (UTD) to a web page defined by the hyperlink TCP/IP.

The second section of the ITAS is an Automatic Account System. It consists of a means to automatically establish accounts in Personal Finance Software called Automatic Account Setup (AAS). It also consists of an improved method to automatically download account statements and data and transaction records, called Automatic Account Download (AAD). There is also a component called Automatic Account Balancing (AAB). Another component of the Automatic Account System, is the ability for Personal Finance Software to categorize and record transactions to individual accounts on a basic, intermediate, or advanced levels.

### FIG. 2 Transaction Code

FIG. 2 shows the basic structure of the Universal Transaction Code (UTC). The UTC consists of three main code sections that can be a unified code within a transaction record, or separated and inserted into the open filler portions of an existing transaction record format.

The first main code section is a Universal Identification Code (UID). This code contains all of the information needed to hyperlink from an electronic statement, to the Universal Identification page of that registrant.

The second main code section is a User Defined Code (UDC). This code contains the information needed to hyperlink from the Universal Identification page, to a specific registrant defined, owned and maintained web page. Code needed to define the action upon reaching the registrant's webpage is also part of the User Defined Code (UDC).

The third main code section is a Universal Category Code (UCC). This code contains information needed by Personal Finance Software (PFS) to automatically record transactions in appropriate accounts based on a standard category list.

I presently prefer that the three main code sections of the Universal Transaction Code (UTC) combined are 96 bytes long.

### FIG. 2a Sample Credit Card Output Format

FIG. 2a shows an existing transaction code sample, and the ability to add the UTC embedded as a unified code, or separated into filler positions in the sample transaction code. The physical structure of the UTC allows for it to be used as an integrated code or placed in filler positions of existing code formats. The sample code in this figure contains 142 bytes of unused filler; however, the preferred structure would be to use the UTC as an integrated single code added to the existing traditional transaction code.

### FIG. 2b Universal Identification Code (UID)

FIG. 2b shows an expanded view of the Universal Identification Code (UID) in FIG. 2. The UID consists of two sub-code sections. The first sub-code of the UID is a Universal Transaction Directory (UTD) website internet protocol address (TCP/IP). The second sub-code of the UID is the Universal Identifier. This is a unique identifier given to any merchant, institution, or individual who registers it in the UTD. Consequently, a merchant can not register for a previously registered identifier. This identifier can be in any format the user desires, as long as there is no duplicate identifier registered. For example, a merchant might choose to register her merchant ID number. A manufacturer might choose to register his UPC manufacturer ID. A bank might choose to register its routing number. One could also register a TCP/IP address. The code is sufficiently long to accommodate all of these formats. If the identifier chosen is shorter than the Universal Identifier, leading zeros could be used to complete the field if needed. Each Universal Identification Code (UID), is a hyperlink address to the registrant's Universal Identification page within the parent Universal Transaction Directory (UTD).

### FIG. 2c User Defined Code (UDC)

FIG. 2c shows an expanded view of the User Defined Code (UDC) in FIG. 2. The User Defined Code (UDC) consists of two sub-code sections.

The first sub-code section of the UDC is a Universal Transaction Directory (UTD) click through hyperlink. The sub-code contains the instructions as to what hyperlink on the UID page to select. I currently prefer that the code be 3 bytes long to accommodate up to 999 hyperlink click through possibilities from a single Universal Identification page.

The second sub-code section of the UDC is a User Defined Reference Number. This sub-code contains information that the UID's web page will need for the current operation. I currently prefer that the identifier be 24 bytes long to accommodate current and future credit card numbers and reference numbers. The User Defined Reference Number can be in any format the user desires, since his web page will be using this identifier.

### FIG. 2d Universal Category Code (UCC)

FIG. 2d shows an expanded view of the Universal Category Code (UCC) format in FIG. 2. The UCC consists of two sub-code sections.

The first sub-code is the one byte transaction type code. This would likely be either a (1) for Debit, or a (2) for credit.

The second sub-code is a Universal Category. There are two parts to the Universal Category. The first two digits define the basic category of the transaction, while the last two digits define the category more specifically. For example, 1900 might be a basic category, and in the extended list, fast food might be 1904. The 19 defines the basic category of DINING OUT, while the 04 defines the type of dining out more specifically as FAST FOOD for intermediate and advanced users. This structure provides for the ability to define 99 basic categories, each with 99 extended categories. The Universal Category Code (UCC) is defined from a consumer's point of view, listing likely categories in an average consumer's Personal Finance Software.

### FIG. 3 Electronic Statement Hyperlink Click Through

Armed with an understanding of the Universal Transaction Code (UTC) structure, we can now discuss its place in the overall Integrated Transaction and Accounting System (ITAS). FIG. 3 is a depiction of an existing credit card statement and how the UTC would be used in an electronic statement. The electronic statements do not require any special structure other than the fact that they must contain all three sections of the UTC to take full advantage of the ITAS system. FIG. 3 illustrates via caption boxes, what would happen if a consumer clicked on an ITAS field within an electronic statement. For instance, if a consumer clicks on a Universal Identification Code (UID) field, she would be directed to a registrant's UID page within the Universal Transaction Directory (UTD). If a consumer clicks on a User Defined Code (UDC) field, she would be directed through the directory to the registrant's own web page defined by the UDC hyperlink click through (10.2.1). That web page would then use the User Defined Code (UDC) reference number (10.2.2) to retrieve the requested information.

### FIG. 4a Universal Transaction Directory (UTD)

FIG. 4a is an example of a Universal Transaction DIRECTORY (UTD) homepage. This page is used for a manual search of Universal Identification pages. Type a UID in the search field and the UTD will take you to a User Identification page and its associated hyperlinks.

### FIG. 4b Universal Identification Page (UID)

FIG. 4b is an example Universal Identification (UID) page for the fictitious Super Mega Corp. within the Universal Transaction Directory (UTD). Universal Identification pages are standard for all registrants in the UTD.

The first section is the Universal Identifier section. This section contains the Universal Identifier of the directory registrant, as well as address and contact information that the UID wishes to provide.

The second section of the Universal Identification page is the User Defined Code (UDC) section. This section contains user defined hyperlink click through numbers, as well as their respective TCP/IP addresses. A consumer can manually hyperlink to those web pages by clicking on the action button next to the code.

The third section of the Universal Identification page is the Universal Transaction Directory search engine. Just like on the UTD homepage, a Universal Identifier typed in this field will link to that User Identification page.

### FIG. 5a-d Automatic Account System—Storage Media

FIG. 5a AUTOMATIC ACCOUNT SETUP (AAS)-Storage Media. FIG. 5a is the first component in the Automatic Account System Flowchart. It is structured such that, Personal Finance Software (PFS) retrieves all data required in order to create an account within the software from storage media received specifically from the institution about the account, This data includes, but is not limited to, account number, institution address, phone number, email, PFS automatic log on and download instructions, etc. . . .

FIG. 5b AUTOMATIC ACCOUNT DOWNLOAD (AAD)-Storage Media. FIG. 5b is the second component in the Automatic Account System Flowchart. This component is structured such that PFS uses the data from AAS to access account information and electronic statements. The key component, other than basic transaction data, is the Universal Transaction Code (UTC). If the transactions and statements are UTC encoded, then PFS can automatically categorize the transactions within the statement. The flowchart depicts the flow in which the standard categories are accepted. It also depicts the flow to manually change the standard category, as well as the flow to modify any transaction by assigning tax exempt, or other modifiers.

FIG. 5c AUTOMATIC ACCOUNT BALANCING (AAB)-Storage Media. FIG. 5c is the third component in the Automatic Account System Flowchart. This third component is an Automatic Account Balancing (AAB) process. Once PFS has performed the AAD, it can then compare and balance transactions from the electronic statement against either a consumer's storage media containing point of sale records, or the merchant's transaction database records via the UTD.

FIG. 5d AUTOMATIC ACCOUNT SYSTEM (AAS) FLOWCHART-Storage Media. FIG. 5d is the complete flowchart integrating AAS, AAD, and AAB within a single decision tree.

### FIG. 6a-d Automatic Account System—Universal Transaction Directory (UTD)

FIG. 6a AUTOMATIC ACCOUNT SETUP (AAS)-UTD. FIG. 6a is the first component in the Automatic Account System Flowchart. It is structured such that, Personal Finance Software (PFS) retrieves all data required in order to create an account within the software from the internet via the Universal Transaction Directory hyperlink click through, or directly from the institutions' web site. This data includes, but is not limited to, account number, institution address, phone number, email, PFS automatic log on and download instructions, etc. . . .

FIG. 6b AUTOMATIC ACCOUNT DOWNLOAD (AAD)-UTD. FIG. 6b is the second component in the Automatic Account System Flowchart. This component is structured such that PFS uses the data from AAS to access account information and electronic statements. The key component, other than basic transaction data, is the Universal Transaction Code (UTC). If the transactions and statements are UTC encoded, then PFS can automatically categorize the transactions within the statement. The flowchart depicts the flow in which the standard categories are accepted. It also depicts the flow to manually change the standard category, as well as the flow to modify any transaction by assigning tax exempt, or other modifiers.

FIG. 6c AUTOMATIC ACCOUNT BALANCING (AAB)-UTD. FIG. 6c is the third component in the Automatic Account System Flowchart. This third component is an Automatic Account Balancing (AAB) process. Once PFS has performed the AAD, it can then compare and balance transactions from the electronic statement against either a consumer's storage media containing point of sale records, or the merchant's transaction database records via the UTD.

FIG. 6d AUTOMATIC ACCOUNT SYSTEM (AAS) FLOWCHART-UTD. FIG. 6d is the complete flowchart integrating AAS, AAD, and AAB within a single decision tree.

### FIG. 7 Advanced Account Categorization

FIG. 7 is a depiction of a current Global Transaction Identification Number (GTIN) bar code. The example shows how fields can be added to the basic GTIN, and goes on to include a field for the weight of a product. Just as the weight field could be added to a standard GTIN, so too could a Universal Category Code (UCC) field be added to a standard GTIN, Electronic Product Code (EPC), or any other product code. In this way, not only could transactions be automatically categorized, but individual items within any given transaction could be automatically categorized.

### FIG. 8 ITAS Summary

FIG. 8 shows a graphic example of the ITAS system. Storage media, in whatever form, will define for the computer and PFS, what account will be used. UTD provides the standardized conduit through which PFS retrieves data. UTC provides the common language that PFS speaks. PFS then creates an account, or PFS can download and categorize and modify transactions, or PFS can balance accounts. Additionally UTD provides the ability to access web sites in a standardized format, as well as access transaction receipts and other user defined data.

### OPERATION

### Integrated Transaction and Accounting System

The invention is an Integrated Transaction and Accounting System (ITAS), which combines several components of a Universal Transaction System, and an Automatic Account System (FIG. 1) to create significant advantages for industry and consumer alike. Consumers will be able to automatically set up all of their accounts in Personal Finance Software (PFS) by inserting encoded storage media in their computer. The storage media would contain all information needed by PFS to not only set up the account automatically, but also how to log on and download information via the internet automatically. Banks, Brokerages etc. . . . would likely give the consumer an encoded CD or DVD. “Smart” Credit Cards would also be encoded with the automatic setup data. Once the consumer has set up all of his accounts in this manner, subsequent insertions of the same media would activate an automatic account download feature. PFS would download the electronic statement for that account, and automatically post the transactions to their respective categories. An additional feature would be the ability for PFS to automatically balance accounts against either personal storage media used at point of sale terminals to record transactions, or from a merchants' transaction database web site. Additionally, consumer's can click on a field in an electronic statement and will be automatically hyperlinked to that institutions' web site.

### Universal Transaction System

Merchants, Institutions and other organizations that conduct business via transactions, will encode their transactions with a Universal Transaction Code (UTC) (FIG. 2). UTC would be a part of all transactions including but not limited to: point of sale terminal purchases, over the phone purchases, bank wire transfers, dividend distributions, royalty payments etc. . . . Just as all transactions include basic traditional items such as Date, Time, Amount, etc. . . . so to will they include the UTC. I presently prefer that the UTC is 96 bytes in length and kept as a unified record. FIG. 2a shows how this unified record could be added to an existing credit card transaction format. It also shows how many credit card formats contain unused “filler” positions that could be utilized to contain the UTC. Regardless of transaction type, or UTC encoding format, there are three components to the UTC.

The first component of the UTC, is the Universal Identification Code (UID). The UID is the key component that industry will use to increase web site traffic. FIG. 2b shows the two fields of the UID. The first field in the UID, is the Universal Transaction Directory IP address. The second field of the UID is the Universal Identifier. Merchants and Institutions can register any Identifier they choose, as long as it is a unique identifier that has not already been registered. FIG. 3 shows a sample electronic credit card statement with the UTC embedded within it. If a consumer clicks on the UID field, she will automatically hyperlink to the Universal Transaction Directory (UTD). More specifically, she will be linked to the UID page for that merchant as depicted in FIG. 4b. Once on the UID page, a consumer can select from a list of standard and merchant specified hyperlinks to the merchant's web site. Up to 999 hyperlinks can be accommodated in the current 96 byte UTC format. In this way, a consumer does not need to know a merchants' web site address or be familiar with its format to find the information she needs. All a consumer needs to do is, click on the UID field within an electronic statement, or type the UID number in the UTD homepage search field as shown on FIG. 4a. The consumer benefits because searching for core information on any registrant's web site is a standardized familiar experience via the standardized format UTD. The UTD registrant benefits because it only has to update its user defined hyperlinks in the directory when changes are made to web site addresses and formats. To the consumer, these changes become transparent since the UTD hyperlink process always remains the same.

The second component of the UTC is the User Defined Code (UDC). The UDC is the key component that industry will use to increase efficiency. FIG. 2c shows the two fields of the UDC. The first field in the UDC, is the UTD hyperlink click through number. The second field of the UDC is the User Defined Reference Number. FIG. 3 shows a sample electronic credit card statement with the UDC embedded within it. If a consumer clicks on the UDC field, he will automatically hyperlink through the Universal Transaction Directory (UTD) to the institution's UID page and directly on to the institution's web site. The page within the institution's web site will be defined by the UTD hyperlink click through (10.2.1). Once there, the institution's web site will use the information provided by the User Defined Reference Number (10.2.2). The first several hyperlink click throughs will be standardized for all UID pages. An example is shown on FIG. 4b. The 001 click through would be for Automatic Account Setup. This would be the hyperlink that storage media received from an institution to set up an account would point to. The 002 click through would be for Automatic Account Download. This would be the hyperlink that PFS would point to, to download electronic statements for posting. The 003 click through would be for Automatic Account Balancing. This would be the hyperlink where point of sale records kept on a personal storage media could be compared with the institutions' records to balance an account within PFS. The 004 click through would be for transaction records. FIG. 3 shows a sample electronic credit card statement with the UTC embedded within it. If a consumer clicks on a UDC field coded with 004 and a transaction reference number, he will automatically hyperlink through the UTD, past the Super Mega Corp UID page, directly to the Super Mega Corps' reference number database. Once there, the Super Mega Corp reference database would use the UDC reference number to call up that specific transaction record. In effect, the consumer would never need to keep paper receipts, since they could always use the electronic statement to retrieve and print them. In addition, merchants could dramatically reduce the number of fraudulent returns, and institutions benefit because consumers would be more inclined to use electronic means of payment. Another benefit of the reference number database hyperlink is the ability for more advanced users to categorize transactions at the item level, which will be discussed later. The UDC field is not just limited to purchase receipts. The best part of the User Defined Code, is that it is user defined. This flexibility enables merchants, institutions, manufacturers etc. . . . to use this field to tag transactions with whatever data is useful for their application.

The third component of the UTC, is the Universal Category Code (UCC). The UCC is the key field that PFS will use to automatically categorize a transaction upon download. FIG. 3 shows a sample electronic credit card statement with the UCC embedded within it. Unlike the UID, and UDC fields, the UCC field is not one that the consumer would click on to hyperlink. The UCC field in an electronic statement, (or transaction record), would be used by PFS to automatically categorize and post each transaction, (or item) that it downloads from the electronic statement. (or transaction reference number database). FIG. 2d shows the two fields of the UCC. The first field in the UCC, is the transaction type. The transaction type would likely be either a 1 (debit), or a 2 (credit) The second field of the UCC is the Universal Category. The Universal Category is 4 digits long. The first two digits define the general category of the transaction. This general basic category is the level at which majority of PFS users will categorize transactions. It contains up to 99 basic category possibilities. FIG. 2d is my current preferred list and will change and grow as needed. Although the average consumer will likely just accept the default basic categories, the UCC also provides for an extended level of categorization with the second two digits of the Universal Category Code. FIG. 2d depicts how the general category of DINING OUT could be extended to several sub levels of dining out. PFS could use the basic 2 digit category level, or it could be set up to categorize at the extended 4 digit level. Additionally, PFS could be customized in a hybrid format. For instance, (FIG. 2d), a basic level consumer might want everything in the 2500 category of entertainment to be posted to “ENTERTAINMENT”. On the other hand, a more advanced level consumer might spend a lot of time gambling and would like to track that separately than all of the other entertainment categories. He therefore configures PFS to record 2504 in a separate “gambling” account, while all of the other 2500 series categories would post to the basic 2500 “ENTERTAINMENT” account. The default PFS configuration would be for transactions to just post to the basic categories, so as to be totally automatic for new and basic users. Industry will code transactions at the extended level, and consumers will allow PFS to either use just the first two (basic), or configure it to use all four (extended) digits. Institutions should have no trouble coding at the extended level since there is generally only one component to a transaction. For instance, a brokerage lists each single item as a separate transaction on the electronic statement. A dividend is separate from sale proceeds on an account statement. A merchant transaction however, usually contains several items. As a result, when a consumer makes a purchase at a mega-store, she might have purchased items that fit into several different categories. For basic users, this is generally not a big issue and can be dismissed. For more advanced users, there needs to be a solution. Based on current technology, the advanced user would click on the UDC in the electronic statement to view the specifics of the individual transaction record and manually categorize each item that she does not want posted to the default category on the electronic statement. Additionally, the multi-product merchant is faced with a dilemma as to what default category to attach to a transaction. The merchant could allow the consumer to define it, but that would lengthen transaction time and would be unacceptable to merchants. The merchant could encode each point of sale terminal with a separate UCC. For instance, the Automotive department terminals would code the transaction with 0300, while the terminals up front would code the transaction with 2900. Additionally, each terminal could have 3 or 4 hard key options. For instance, a terminal might have 3 keys, one for 2900 groceries, one for 1300 clothing, and one for 0300 Automotive. The, preferred option would be for merchants to electronically tag each item with a UCC. Current technology would require that the UCC be entered in the point of sale system in the same way that the item's GTIN bar code is/was entered. Once the UCC for each item is in the system, point of sale terminals could code a transaction with whatever category in the transaction had the highest dollar value, or the category most purchased. Future technology would also use this option. FIG. 7 represents a new GTIN bar coded item with a product weight field added. This same code could also add a UCC field. This way, the merchant would not have to separately add the UCC when entering items in the point of sale system. The next generation product code is the Electronic Product Code (EPC) using Radio Frequency Identification Tags. This technology would easily accommodate the UCC code. Accordingly, even though the overall transaction record was the highest dollar amount UCC, an advanced user could click on the UDC in the electronic statement to hyperlink to the transaction receipt via the reference number database. Since each item is electronically tagged with its own UCC, PFS could automatically download and categorize each individual item.

### Automatic Account System—Storage Media

The core component of the Automatic Account System is Personal Finance Software (PFS). The sub-components of the Automatic Account System are enhancements to PFS. These sub-components are: Automatic Account Setup (AAS), Automatic Account Download (AAD), Automatic Account Balancing (AAB), and Electronic Statement Manual Hyperlinks.

The first sub-component of the Automatic Account System, AAS is shown in FIG. 5a. The first step (100) would be for the consumer to place storage media in his home computer with PFS installed. In the past, storage media would have likely meant floppy disks. Currently, storage media generally means CD's, DVD's or USB jump drives. In the future “storage media” will likely translate to smart cards, RF transmitters, and portable mini hard drives. Simple accounts such as a brokerage account, or savings account would likely be on CD or DVD for cost savings, while point of sale accounts such as credit card or debit card accounts would likely be on read write capable smart cards. Regardless of the storage media format, PFS will auto run step (100) when the media is inserted just as is currently the case when a CD is inserted in a computer. Once PFS recognizes the media, it will check the media (101) to see if the account on that media has already been set up on the computer. If the answer is no, then (102) PFS will automatically use the standardized ITAS data on the disk that is needed to establish the account. PFS will also install data from the storage media that is required to utilize the features of the Integrated Transaction and Accounting System (ITAS).

The second sub-component of the Automatic Account System, AAD is shown in FIG. 5b.

Basic User—The consumer will insert storage media in the computer (100) to define what account will be used. If the account on that storage media has already been established, (101) then PFS can be set up to automatically, or prompt (103) to download the latest statement (104). After download of the statement is complete, PFS will prompt whether on not to accept the default category codes (105). The basic user will answer yes to accept the default codes. PFS will then prompt whether or not to attach a modifier such as tax exempt status to any transactions (106). The basic user will answer no and PFS will automatically post all transactions to their respective default categories (107).
Intermediate User—The consumer will insert storage media in the computer (100) to define what account will be used. If the account on that storage media has already been established, (101) then PFS can be set up to automatically, or prompt (103) to download the latest statement (104). After download of the statement is complete, PFS will prompt whether on not to accept the default transaction category codes (105). The intermediate user will answer no, so as to change the default codes. The user will then click on the specific transaction to change (108). PFS will then prompt whether to access the transaction record from the merchant in order to change individual items (109). The intermediate user will answer no, then PFS will prompt for a category from the UCC standardized list to assign to the chosen transaction (110), then prompt whether to categorize another transaction (111). The intermediate user will answer no, then the user is prompted whether to attach a modifier to any transaction (106). If a modifier is desired, such as tax exempt, the user will click the applicable transaction (116), then click the modifier from a list (117) and repeat. If no modifier is desired, the electronic statement is completely categorized and modified, and therefore posted within PFS (107).
Advanced User—The advanced user will accomplish all of the steps that an Intermediate User would accomplish to categorize and modify at the transaction level, plus he will likely want to categorize and modify at the item level as well. At step (109) the advanced user would answer yes, to categorize individual items in a transaction. He would then click on the UDC hyperlink for that transaction within the electronic statement (112), in order to hyperlink to that UID's reference database web page. Once there, PFS would prompt whether to accept the default categories assigned to each item by the merchant's point of sale (POS) system (113). If the answer is yes then PFS moves on to the modifier module. If the answer is no, then PFS prompts to click the individual item to change and supplies the UCC standard list in a dropdown menu (114). PFS then asks if you want to change another item (115).
(Note: the merchant's (POS) system could assign item categories by manual entry, GTIN, EPC, or other means)

The third sub-component of the Automatic Account System, AAB is shown in FIG. 5b. The consumer will insert storage media in the computer (100) to define what account will be used. If the account on that storage media has already been established, (101) then PFS can be set up to automatically, or prompt (103) to download the latest statement (104). If no is answered to the download prompt, PFS prompts whether to begin account balancing (118). If yes is answered, the consumer will insert portable storage media containing point of sale transaction records in the computer (119). This storage media would likely be a smart card with storage and read write capability. The same transaction record that is sent to the credit card company is also sent from the POS terminal to the smart card. PFS would then automatically upload the portable storage media transactions, then log on and download the transactions posted to the account (120). The uploaded transactions are balanced against the downloaded transactions, and a report is generated for transactions that do not match (121). Each PFS vendor will handle this information as it sees fit.

The fourth sub-component of the Automatic Account System, Electronic Statement Manual Hyperlinks, is shown in FIG. 5d along with the rest of the Automatic Account System Flowchart for the other 3 sub-components. The consumer will insert storage media in the computer (100) to define what account will be used. If the account on that storage media has already been established, (101) then PFS can be set up to automatically, or prompt (103) to download the latest statement (104). If no is answered to the download prompt, PFS prompts whether to begin account balancing (118). If no is answered, the electronic statement is opened, but not downloaded, and the user can manually click on any UID to hyperlink to the UID page within the UTD, or any UDC field to hyperlink through the UTD to the UID web page that would enable the consumer to view and print transaction records/receipts (122).

### Alternate Embodiment

### Automatic Account System—Universal Transaction Directory (UTD)

The core component of the Automatic Account System is Personal Finance Software (PFS). The sub-components of the Automatic Account System are enhancements to PFS. These sub-components are: Automatic Account Setup (AAS), Automatic Account Download (AAD), Automatic Account Balancing (AAB), and Electronic Statement Manual Hyperlinks.

The first sub-component of the Automatic Account System, AAS is shown in FIG. 6a. The first step (200) would be for the consumer to navigate via internet browser to the Universal Transaction Directory (UTD) home page, (FIG. 4a) and type in the Universal Identifier given by the institution in the search field. The UTD will then link you to the institution's User Identification page within the UTD (FIG. 4b). The next step would be to click on the 001 hyperlink (201) for AAS. The UTD would then hyperlink the user to the institution's web page that contains all of the information PFS needs to set up the account. PFS will automatically use the standardized data on the web page that is needed to establish the account (202). PFS will also install data from the web page that is required to utilize the features of the Integrated Transaction and Accounting System (ITAS).

The second sub-component of the Automatic Account System, AAD is shown in FIG. 6b.

Basic User—The first step (200) would be for the consumer to navigate via internet browser to the Universal Transaction Directory (UTD) home page, (FIG. 4a) and type in the Universal Identifier given by the institution in the search field. The UTD will then link you to the institution's User Identification page within the UTD (FIG. 4b). The next step would be to click on the 002 hyperlink (203) for AAD.
Then PFS will automatically, download the latest statement (204). After download of the statement is complete, PFS will prompt whether on not to accept the default category codes (205). The basic user will answer yes to accept the default codes. PFS will then prompt whether or not to attach a modifier such as tax exempt status to any transactions (206). The basic user will answer no and PFS will automatically post all transactions to their respective default categories (207).
Intermediate User—The first step (200) would be for the consumer to navigate via internet browser to the Universal Transaction Directory (UTD) home page, (FIG. 4a) and type in the Universal Identifier given by the institution in the search field. The UTD will then link you to the institution's User Identification page within the UTD (FIG. 4b). The next step would be to click on the 002 hyperlink (203) for AAD.
Then PFS will automatically, download the latest statement (204). After download of the statement is complete, PFS will prompt whether on not to accept the default category codes (205). The intermediate user will answer no, so as to change the default codes. The user will then click on the specific transaction to change (208). PFS will then prompt whether to access the transaction record from the merchant in order to change individual items (209). The intermediate user would answer no, then PFS will prompt for a category from the UCC standardized list to assign to the chosen transaction (210), then prompt whether to categorize another transaction (211). The intermediate user would answer no, then the user is prompted whether to attach a modifier to any transaction (206). If a modifier is desired, such as tax exempt, the user will click the applicable transaction (216), then click the modifier from a list (217) and repeat. If no modifier is desired, the electronic statement is completely categorized and modified, and therefore posted within PFS (207).

### Advanced User—

The advanced user will accomplish all of the steps that an Intermediate User would accomplish to categorize and modify at the transaction level, plus he will likely want to categorize and modify at the item level as well. At step (209) the advanced user would answer yes, to categorize individual items in a transaction. He would then click on the UDC hyperlink for that transaction within the electronic statement (212), in order to hyperlink to that UID's reference database web page. Once there, PFS would prompt whether to accept the default categories assigned to each item by the merchant's point of sale (POS) system (213). If the answer is yes then PFS moves on to the modifier module. If the answer is no, then PFS prompts to click the individual item to change and supplies the UCC standard list in a dropdown menu (214). PFS then asks if you want to change another item (215).
(Note: the merchant's (POS) system could assign item categories by manual entry, GTIN, EPC, or other means)

The third sub-component of the Automatic Account System, AAB is shown in FIG. 6c. The first step (200) would be for the consumer to navigate via internet browser to the Universal Transaction Directory (UTD) home page, (FIG. 4a) and type in the Universal Identifier given by the institution in the search field. The UTD will then link you to the institution's User Identification page within the UTD (FIG. 4b). The next step would be to click on the 003 hyperlink (203) for AAB. PFS will prompt to balance electronic statement amounts with UDC reference number database amounts (219). If the answer is yes, PFS automatically cycles through each UDC on the electronic statement to balance the merchant reference number database amount with the institution electronic statement amount (220), and a report is generated for transactions that do not match (221). Each PFS vendor will handle this information as it sees fit.

The fourth sub-component of the Automatic Account System, Electronic Statement Manual Hyperlinks, is shown in FIG. 6d along with the rest of the Automatic Account System Flowchart for the other 3 sub-components. The first step (200) would be for the consumer to navigate via internet browser to the Universal Transaction Directory (UTD) home page, (FIG. 4a) and type in the Universal Identifier given by the institution in the search field. The UTD will then link you to the institution's User Identification page within the UTD (FIG. 4b). The next step would be to click on the 003 hyperlink (203) for AAB. PFS will prompt to balance electronic statement amounts with UDC database amounts (219). If the answer is no, the electronic statement is opened, but not downloaded, and the user can manually click on any UID to hyperlink to the UID page within the UTD, or any UDC field to hyperlink through the UTD to the UID web page that would enable the consumer to view and print transaction records/receipts (222).

I claim:

1. A directory for data management comprising:
(a) unique, mutually exclusive identification codes submitted by entities who wish to register their identity in said directory,
(b) a means to search said directory for data,
(c) a standard base page for each directory registrant,
(d) a plurality of web page link fields within each said standard base page for each said directory registrant.

2. The directory of claim 1 wherein said means to search comprises:
(a) a field on all directory pages for manual entry of the identification code to be searched, thereby calling up said standard base page for said directory registrant,
(b) an automatic search means wherein said field on all directory pages is entered by finance software,
(c) said automatic search means wherein said field on all directory pages is entered by an electronic link,

3. The directory of claim 1 wherein said plurality of web page link fields includes a plurality of standardized link fields selected from the group consisting of:
(a) an automatic account setup link to data required for said finance software to create an account,
(b) an automatic account download link to data required for a finance software program to download transaction data,
(c) an automatic account balancing link to data required for said finance software to balance an account with transactions from storage media used at a point of sale terminal,
(c) said automatic account balancing link to data required for said finance software to balance an account with transactions with a reference number database,
(d) a reference number database link to transaction records of any said directory registrant accessed via a reference number given by said directory registrant,
(e) a homepage link to an internet homepage of any said directory registrant.

4. The directory of claim 1 wherein said plurality of web page link fields includes a plurality of user defined link fields whereby said directory registrants define the web page that any said user defined link field points to.
